(19) United States
(12) Patent Application Publication
(10) Pub. No.: US 2023/0305419 A1
(43) Pub. Date: Sep. 28, 2023

(54) TWO COMPONENT DEVELOPER CONTAINING TONER AND MAGNETIC CARRIER, AND METHOD FOR PRODUCING TWO COMPONENT DEVELOPER

(71) Applicant: CANON KABUSHIKI KAISHA, Tokyo (JP)

(72) Inventors: HIROKI WATANABE, Chiba (JP); ICHIRO KANNO, Chiba (JP); MARI KABURAGI, Chiba (JP); HAYATO IDA, Ibaraki (JP)

(21) Appl. No.: 18/182,741

(22) Filed: Mar. 13, 2023

(30) Foreign Application Priority Data
Mar. 24, 2022 (JP) 2022-048993
Feb. 2, 2023 (JP) 2023-014700

(51) Int. Cl. G03G 9/107; G03G 9/113; G03G 9/093; G03G 9/08; G03G 9/087

(52) U.S. Cl. CPC G03G 9/1075; G03G 9/1133; G03G 9/09328; G03G 9/081; G03G 9/08791

(57) ABSTRACT

A two component developer comprising a toner and a specific magnetic carrier, wherein a toner particle in the toner comprises a surface layer comprising an organosilicon polymer, electrical conductivity of a filtrate obtained by filtering off the toner using a specific procedure is 1.0 to 2.5 μS/cm, and when dC (atomic %) denotes carbon concentration, dO (atomic %) denotes oxygen concentration and dSi (atomic %) denotes silicon concentration, as measured by ESCA, at the surface of the toner particle, then the dC, the dO and the dSi satisfy the following formulae:

40.0≤dC/(dC+dO+dSi)×100≤60.0

10.0≤dSi/(dC+dO+dSi)×100≤26.0.

### BACKGROUND OF THE INVENTION

### Field of the Invention

The present disclosure relates to a two component developer, which contains a toner and a magnetic carrier and which can be used in electrophotography systems, electrostatic recording systems, electrostatic printing systems, and the like, and a method for producing the two component developer.

### Description of the Related Art

As use of copiers and printers has become more widespread, higher performance has been required of developers. Attention has been focused in recent years on digital printing techniques known as print on demand (POD), in which printing is directly carried out without the use of a plate-making process. In the POD market, printed matters with higher image quality than in the past need to be obtained in order to cope with a broad range of media (paper types), even if high-volume printing is carried out at high speed over a long period of time. Therefore, developers require stable charging performance and environmental stability over a long period of time.

Furthermore, copiers and printers need to exhibit shorter recovery times from sleep modes. Therefore, toners that constitute developers need to exhibit excellent charge maintaining properties so that there is little change in charge quantity after a long period in sleep mode.

In copiers used in the POD market, two component developers containing a toner and a carrier are used in order to achieve high speeds and high quality. However, in cases where high quality images are outputted continuously, components derived from the toner can contaminate the surface of a carrier, meaning that charge-providing performance attributable to the magnetic carrier may decrease, and the charging performance of the toner may therefore decrease. Therefore, there is a need for a two component developer in which toner charging is stable over a long period of time.

Conventionally, in order to improve the charge quantity of developers, external additives (inorganic particles such as silica, titania or alumina) were deposited or fixed on toner particle surfaces.

However, external additives tend to contaminate components in developing tanks and carriers, meaning that it is difficult to make full use thereof. Furthermore, machines have become faster and have longer service lives in recent years, and it has become much more difficult to both improve charge quantity and suppress contamination of components. With such circumstances in mind, it is desirable to create techniques for improving the charge quantity of a toner and suppressing contamination of components.

A technique in which external additives are not used has been developed as an example of a method for solving these problems. More specifically, a method including coating an alkoxysilane polymer on a toner particle surface by using a sol-gel process has been developed.

Japanese Patent Application Publication No. 2013-120251 discloses a toner in which a toner base particle surface is coated with a tetraalkoxysilane polymer in order to solve problems inherent in conventional external additives, such as detachment and embedding.

Japanese Patent Application Publication No. 2014-130238 discloses a toner in which a toner particle surface is coated mainly with a trialkoxysilane polymer in order to obtain a toner having excellent development durability and so on.

### SUMMARY OF THE INVENTION

However, it has been found that, in cases where images are outputted over a long period of time in a low temperature low humidity environment or a normal temperature normal humidity environment using a two component developer including a toner disclosed in Japanese Patent Application Publication No. 2013-120251 or Japanese Patent Application Publication No. 2014-130238 and a magnetic carrier having a resin coat layer, the tetraalkoxysilane polymer or trialkoxysilane polymer coated on toner particle surfaces is affected by humidity, and the toner became excessively charged. In such a case, the toner is unlikely to fly from a developing part because electrostatic forces of attachment between the toner and the magnetic carrier increase. As a result, image density and image density uniformity in printed matters may decrease, and it may not be possible to obtain printed matters having high image quality.

In addition, in the toners disclosed in Japanese Patent Application Publication Nos. 2013-120251 and 2014-130238, it has been found that there is significant change in the charge quantity of the toner before and after a copier or printer is in sleep mode for a long time, and that there is still room for improvement in terms of charge maintaining properties in high temperature high humidity environments.

The present disclosure relates to a two component developer comprising a toner and a magnetic carrier, wherein
the magnetic carrier comprises a magnetic carrier core particle and a resin coat layer formed on a surface of the magnetic carrier core particle,
the toner comprises a toner particle comprising a binder resin,
the toner particle comprises a surface layer comprising an organosilicon polymer,
after the toner and ion exchanged water are mixed to toner concentration of 1.0 mass %, and are shaken for 1 minute, and then filtering off the toner, electrical conductivity of a filtrate is 1.0 to 2.5 μS/cm, and
when dC (atomic %) denotes a carbon concentration, dO (atomic %) denotes an oxygen concentration and dSi (atomic %) denotes a silicon concentration, as measured by ESCA, at a surface of the toner particle, then the dC, the dO and the dSi satisfy formula (1) and formula (2) below:

40.0≤dC/(dC+dO+dSi)×100≤60.0 (1)

10.0≤dSi/(dC+dO+dSi)×100≤26.0 (2).

Further, the present disclosure relates to a method for producing the above two component developer, wherein
the method comprises a step for mixing the magnetic carrier and the toner having the toner particle,
a step for producing the toner particle comprises:
a first step for obtaining a hydrolyzate of an organosilicon compound having a structure represented by formula (Y) below;
a second step for mixing the hydrolyzate obtained in the first step, toner base particles dispersed in an aqueous medium, and an alkaline aqueous medium, subjecting at least a part of the hydrolyzate to a polycondensation reaction, and forming a surface layer comprising an organosilicon polymer on the toner base particles;
a third step for subjecting the organosilicon polymer comprised in the surface layer formed on the toner base particles to a hydrophobic treatment, and then obtaining a toner particle comprising an organosilicon polymer; and
a fourth step for washing the toner particle obtained in the third step with water:

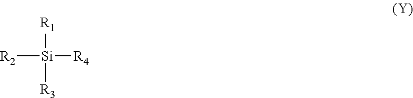

in formula (Y), R1 denotes a hydrocarbon group having 1 to 6 carbon atoms or an aryl group, and R2, R3 and R4 each independently denote a halogen atom, a hydroxy group, an acetoxy group or an alkoxy group.

The present disclosure provides a two component developer in which a toner exhibits charge stability even if images are outputted over a long period of time in a low temperature low humidity environment or a normal temperature normal humidity environment using a two component developer comprising a toner and a magnetic carrier having a resin coat layer, meaning that image density, image density uniformity and image quality of printed matters are good, there is little change in charge quantity after a copier or printer spends a long period in sleep mode, and charge maintaining properties in high temperature high humidity environments are good. Further features of the present invention will become apparent from the following description of exemplary embodiments with reference to the attached drawings.

### BRIEF DESCRIPTION OF THE DRAWINGS

FIG. 1 is an example of a heat sphering treatment apparatus; and

FIG. 2 is methanol dropping transmittance curve.

### DESCRIPTION OF THE EMBODIMENTS

In the present disclosure, the terms “from XX to YY” and “XX to YY”, which indicate numerical ranges, mean numerical ranges that include the lower limits and upper limits that are the end points of the ranges. In cases where numerical ranges are indicated incrementally, upper limits and lower limits of the numerical ranges can be arbitrarily combined.

The term “monomer unit” describes a reacted form of a monomeric material in a polymer. For example, one carbon-carbon bonded section in a principal chain of polymerized vinyl monomers in a polymer is given as one unit. A vinyl monomer can be represented by the following formula (Z):

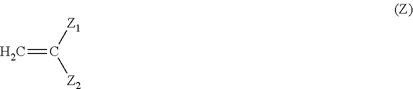

in formula (Z), Z₁ represents a hydrogen atom or alkyl group (preferably a alkyl group having 1 to 3 carbon atoms, or more preferably a methyl group), and Z₂ represents any substituent.

The present disclosure relates to a two component developer comprising a toner and a magnetic carrier, wherein
the magnetic carrier comprises a magnetic carrier core particle and a resin coat layer formed on a surface of the magnetic carrier core particle,
the toner comprises a toner particle comprising a binder resin,
the toner particle comprises a surface layer comprising an organosilicon polymer,
after the toner and ion exchanged water are mixed to toner concentration of 1.0 mass %, and are shaken for 1 minute, and then filtering off the toner, electrical conductivity of a filtrate is 1.0 to 2.5 μS/cm, and
when dC (atomic %) denotes a carbon concentration, dO (atomic %) denotes an oxygen concentration and dSi (atomic %) denotes a silicon concentration, as measured by ESCA, at a surface of the toner particle, then the dC, the dO and the dSi satisfy formula (1) and formula (2) below:

40.0≤dC/(dC+dO+dSi)×100≤60.0 (1)

10.0≤dSi/(dC+dO+dSi)×100≤26.0 (2).

The inventors of the present invention think that the mechanism by which this effect is achieved is as follows.

The toner comprises a toner particle comprising a binder resin.

The toner particle comprises a surface layer comprising an organosilicon polymer, and if dC (atomic %) denotes a carbon concentration, dO (atomic %) denotes an oxygen concentration and dSi (atomic %) denotes a silicon concentration, as measured by X-ray photoelectric spectrophotometry (also referred to as ESCA hereinafter), at the surface of the toner particle, then dC, dO and dSi satisfy formula (1) and formula (2) below.

40.0≤dC/(dC+dO+dSi)×100≤60.0 (1)

10.0≤dSi/(dC+dO+dSi)×100≤26.0 (2)

If dC, dO and dSi satisfy formula (1), this shows that there is a high carbon concentration at the toner particle surface. In addition, if dC, dO and dSi satisfy formula (2), this shows that there is a low silicon concentration at the toner particle surface.

In addition, it is preferable for dC, dO and dSi to satisfy formula (1′) and/or (2′) below.

42.0≤dC/(dC+dO+dSi)×100≤58.0 (1′)

12.0≤dSi/(dC+dO+dSi)×100≤24.0 (2′)

As a result of diligent research, the inventors of the present invention confirmed that charging performance at the toner surface was uniform in a case where the carbon concentration was high and the silicon concentration was low at the toner particle surface. The reason for this is not clear, but it is thought to be because the surface of the organosilicon polymer contained in the surface layer of the toner particle and the matrix of the toner particle (hereinafter referred to as the toner base particle) become closer in terms of triboelectric series. As a result, it was understood that electrostatic forces of attachment between the toner and the carrier decrease, the toner tends to fly from a developing part, a decrease in image density and image density uniformity in a printed material is suppressed, and a high quality image can be obtained.

An example of a method for adjusting dC, dO and dSi so as to satisfy formulae (1) and (2) above is a method comprising forming a surface layer containing an organosilicon polymer on a toner base particle and then subjecting the organosilicon polymer contained in the surface layer formed on the toner base particle to a hydrophobic treatment. Suitable hydrophobic treatment methods and hydrophobic treatment agents are described later.

With respect to a toner, after the toner and ion exchanged water are mixed to toner concentration of 1.0 mass %, and are shaken for 1 minute, and then filtering off the toner, electrical conductivity of a filtrate is 1.0 to 2.5 μS/cm, and preferably 1.5 to 2.3 μS/cm.

In cases where the carbon concentration is high and the silicon concentration is low at the toner particle surface, as mentioned above, charge tends to accumulate at the toner surface. Therefore, the charge quantity of the toner increases over time, and it is difficult to stably output high quality images. Therefore, it is important for the electrical conductivity of the filtrate obtained by filtering off the toner to be 1.0 μS/cm or more.

If the electrical conductivity of the filtrate obtained by filtering off the toner is 1.0 μS/cm or more, this shows that ion components are present at a suitable quantity in the toner. Ion components have the effect of leaking charge to a suitable extent. Therefore, if ion components are present at a suitable quantity in the toner, it is thought that it is possible to prevent the toner from becoming excessively charged when the toner and the magnetic carrier are mixed and charged.

As a result, even in cases where images are outputted for a long period of time in a low temperature low humidity environment or a normal temperature normal humidity environment, the toner exhibits charge stability, and image density, image density uniformity and image quality are therefore improved.

Meanwhile, if the electrical conductivity of the filtrate obtained by filtering off the toner is 2.5 μS/cm or less, this means the following:

Conventional organosilicon polymers coated on toner surfaces tended to be affected by moisture, and caused leakage of charge in high temperature high humidity environments in some cases. Therefore, it was understood that there is significant change in the charge quantity of a toner before and after a copier or printer is in sleep mode, and charge maintaining properties in a high temperature high humidity environment deteriorate.

As a result of diligent research, the inventors of the present invention found that the problems mentioned above could be solved in cases where the carbon concentration at the toner particle surface was high and in cases where the electrical conductivity of the filtrate obtained by filtering off the toner was 2.5 μS/cm or less.

In addition, in cases where the electrical conductivity of the filtrate obtained by filtering off the toner exceeds 2.5 μS/cm, large quantities of ion components are present in the toner, the effect of the organosilicon polymer at the toner particle surface is not exhibited, and the toner does not become sufficiently charged. As a result, there is significant change in the charge quantity of the toner before and after a copier or printer is in sleep mode, and charge maintaining properties in a high temperature high humidity environment deteriorate.

The electrical conductivity of the filtrate obtained by filtering off the toner can be adjusted by altering the amount of washing of the toner particles, as explained below, and can be measured using a method explained below.

Organosilicon Polymer

The method for producing the organosilicon polymer is not particularly limited, but an example of a typical production method is a production method known as a sol-gel method.

A sol-gel method is a method comprising carrying out hydrolysis and condensation polymerization in a solvent using a metal alkoxide M(OR_{y})n (M is a metal atom, O is oxygen, R_{y} is a hydrocarbon, and n is the valency of the metal) as a starting material, and gelling via a sol state, and is a method used for synthesizing glass, ceramics, organic-inorganic hybrids and nano-composites. If this production method is used, it is possible to produce functional materials having a variety of forms, such as surface layers, fibers, bulk bodies and fine particles, from a liquid phase at a low temperature.

More specifically, the organosilicon polymer comprised in the surface layer of the toner particle is preferably produced by subjecting a silicon compound such as an alkoxysilane to hydrolysis and condensation polymerization.

In addition, a preferred embodiment is one in which the surface layer that comprises the organosilicon polymer is provided uniformly on the toner particle surface. If the surface layer comprising the organosilicon polymer is provided uniformly on the toner particle surface, it is possible to lower attachment forces to transfer components and obtain a toner capable of yielding good images having little image graininess.

It is possible to use a SEM or the like to confirm that the toner particle comprises a surface layer comprising the organosilicon polymer and that the surface layer comprising the organosilicon polymer is provided uniformly on the toner particle surface.

Furthermore, because the sol-gel method starts with a solution and forms a material by gelling the solution, it is possible to produce a variety of fine structures and shapes.

These fine structures and shapes can be adjusted by altering the reaction temperature, the reaction time, the reaction solvent, the pH, the type and added quantity of an organosilicon compound, and so on.

The organosilicon polymer is preferably an organosilicon polymer obtained by polymerizing an organosilicon compound having a structure represented by formula (Y) below.

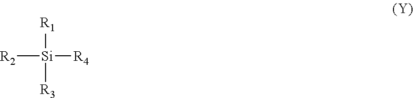

In formula (Y), R₁ denotes a hydrocarbon group having 1 to 6 carbon atoms or an aryl group, and R₂, R₃ and R₄ each independently denote a halogen atom, a hydroxy group, an acetoxy group or an alkoxy group (also referred to as a “reactive group” hereinafter).

The hydrocarbon group in R₁ is a hydrocarbon group other than an aryl group. If R₁ is a hydrocarbon group or an aryl group, it is possible to improve the hydrophobic properties of the organosilicon polymer and obtain a toner having excellent environmental stability. Because variations in charge amount in different environments tend to increase in cases where R₁ is highly hydrophobic, it is preferable for R₁ to have 1 to 3 carbon atoms in view of environmental stability. Methyl groups, ethyl groups and propyl groups can be given as preferred examples of hydrocarbon groups having 1 to 3 carbon atoms, and a phenyl group can be given as a preferred example of an aryl group. In this case, charging performance and suppression of fogging are improved. From the perspectives of environmental stability and storage stability, R₁ is more preferably a methyl group.

If R₂, R₃ and R₄ are reactive groups, these reactive groups undergo hydrolysis, addition polymerization and condensation polymerization to form a crosslinked structure, and it is possible to obtain a toner that is excellent in terms of resistance to contamination of components and development durability. Methoxy groups and ethoxy groups are preferred from the perspectives of exhibiting mild hydrolyzability at room temperature and increasing formability at the toner base particle surface. In addition, hydrolysis, addition polymerization and condensation polymerization of R₂, R₃ and R₄ can be controlled by adjusting the reaction temperature, the reaction time, the reaction solvent and the pH.

The method for producing the organosilicon polymer is not particularly limited, and the organosilicon polymer can be produced by, for example, dispersing toner base particles in an aqueous solvent, adding a silane compound dropwise, subjecting the silane compound to hydrolysis and condensation reactions using a catalyst, filtering off the obtained suspension, and drying. The fine structure and shape of the silicon polymer can be controlled by altering the type and blending proportion of the catalyst, the reaction initiation temperature, the duration of dropwise addition, and so on. A well-known catalyst can be advantageously used as the catalyst. Specific examples of acidic catalysts include acetic acid, hydrochloric acid, hydrofluoric acid, sulfuric acid and nitric acid, and specific examples of basic catalysts include aqueous ammonia, sodium hydroxide and potassium hydroxide.

The method for producing the toner particle is not particularly limited, but it is preferable to include the following method. A preferred production method includes a first step for obtaining a hydrolyzate of an organosilicon compound having a structure represented by formula (Y) above, a second step for mixing the hydrolyzate obtained in the first step, toner base particles dispersed in an aqueous medium, and an alkaline aqueous medium, and subjecting at least a part of the hydrolyzate to a polycondensation reaction, and forming a surface layer comprising an organosilicon polymer on the toner base particles, a third step for subjecting the organosilicon polymer comprised in the surface layer formed on the toner base particles to a hydrophobic treatment, and then obtaining toner particles having a surface layer comprising the organosilicon polymer, and a fourth step for washing the toner obtained in the third step with water.

In the first step, the organosilicon compound and the catalyst are brought into contact with each other using a method such as stirring or mixing in an aqueous solution in which an acidic catalyst or a basic catalyst is dissolved, thereby obtaining a raw material solution that contains a hydrolyzate of the organosilicon compound. A well-known catalyst can be advantageously used as the catalyst. Specific examples of acidic catalysts include acetic acid, hydrochloric acid, hydrofluoric acid, sulfuric acid and nitric acid, and specific examples of basic catalysts include aqueous ammonia, sodium hydroxide and potassium hydroxide.

The usage quantity of the catalyst should be adjusted, as appropriate, according to the type of organosilicon compound and catalyst being used.

The usage quantity of water is preferably 2 to 15 moles relative to 1 mole of the organosilicon compound. The hydrolysis reaction progresses sufficiently if the amount of water is 2 moles or more, and productivity is improved if the amount of water is 15 moles or less.

The reaction temperature is not particularly limited, and may be room temperature or a heated state, but it is preferable to carry out the reaction in a state maintained at a temperature of 10 to 60° C. in order for the hydrolyzate to be obtained in a short time and to suppress a partial condensation reaction of the produced hydrolyzate. The reaction time is not particularly limited, and should be selected as appropriate in view of the reactivity of the organosilicon compound being used, the composition of the reaction liquid obtained by mixing the organosilicon compound, an acid and water, and productivity.

In the second step, the raw material solution obtained in the first step is mixed with a toner base particle dispersed solution obtained by dispersing toner base particles in an aqueous medium. Next, a basic catalyst is added, at least a part of the hydrolyzate of the organosilicon compound is subjected to a polycondensation reaction, and a surface layer containing an organosilicon polymer is formed on the toner base particles. The toner base particles on which the surface layer containing the organosilicon polymer has been formed may be toner particles having a surface layer containing the organosilicon polymer.

The basic catalyst acts as a catalyst for the polycondensation reaction in the second step. A well-known catalyst can be advantageously used as the basic catalyst in the second step, and examples thereof include: alkali metal hydroxides such as lithium hydroxide, sodium hydroxide and potassium hydroxide; ammonia; and organic amines such as monomethylamine and dimethylamine.

It is preferable to incorporate a dispersion stabilizer in the aqueous medium in order to disperse the toner base particles in the aqueous medium. Substances listed below can be used as dispersion stabilizers.

Examples of inorganic dispersion stabilizers include tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica and alumina.

In addition, examples of organic dispersion stabilizers include poly(vinyl alcohol), gelatin, methyl cellulose, methylhydroxypropyl cellulose, ethyl cellulose, sodium carboxymethyl cellulose and starch.

From the perspective of ease of removal of the dispersion stabilizer after the surface layer containing the organosilicon polymer is formed on the toner base particles, it is preferable to use an inorganic dispersion stabilizer, and more preferable to use a poorly water-soluble inorganic dispersion stabilizer.

In cases where a poorly water-soluble inorganic dispersion stabilizer is used to disperse the toner base particles in the aqueous medium, the added quantity of the dispersion stabilizer is preferably 0.2 to 2.0 parts by mass relative to 100.0 parts by mass of the toner base particles. In addition, it is preferable to prepare a toner base particle dispersion using water at a quantity of 300.0 to 3000.0 parts by mass relative to 100.0 parts by mass of the toner base particles.

In cases where an aqueous medium is prepared by dispersing a poorly water-soluble inorganic dispersing agent, as mentioned above, in the present disclosure, a commercially available dispersion stabilizer may be used as-is. In addition, in order to obtain a dispersion stabilizer having a fine and uniform particle size, a poorly water-soluble inorganic dispersing agent may be produced under high speed stirring in a liquid medium such as water.

More specifically, in a case where tricalcium phosphate is to be used as a dispersion stabilizer, it is possible to obtain a preferred dispersion stabilizer by mixing an aqueous solution of sodium phosphate with an aqueous solution of calcium chloride under high speed stirring so as to form fine particles of tricalcium phosphate.

Use of tricalcium phosphate as a dispersion stabilizer is preferred from the perspective of shape stability and production stability of the surface layer containing the organosilicon polymer formed on the toner base particles. The reason for this is due to the crystal structure of tricalcium phosphate. Tricalcium phosphate has a hexagonal crystal structure in which calcium ions are arranged in the center and phosphate ions are arranged at the periphery. Therefore, calcium ions readily align with the aqueous medium at the surface of the toner base particles, electrostatic attraction increases to silanol groups, which are hydrolyzed parts of the organosilicon compound, in the aqueous medium, and a surface layer containing the organosilicon polymer is readily formed.

The third step is a step in which the organosilicon polymer contained in the surface layer formed on the toner base particles is subjected to a hydrophobic treatment. The hydrophobic treatment method is not particularly limited, but it is preferable to add an organic solvent to the dispersion following completion of the second step, then add a hydrophobic treatment agent, and cause a reaction between the hydrophobic treatment agent and the organosilicon polymer contained in the surface layer formed on the toner base particles. In such a case, it is more preferable to add the organic solvent at a quantity of 20 to 400 parts by mass relative to 100 parts by mass of the toner base particle dispersed solution dispersed in the aqueous medium. The hydrophobic treatment agent is highly hydrophobic and is unlikely to be affected by moisture. Details relating to the hydrophobic treatment agent are explained later.

The hydrophobic treatment agent used in the third step is highly hydrophobic and can, in some cases, be difficult to mix with the toner base particle dispersed solution, which contains an aqueous medium. Therefore, by adding an organic solvent to facilitate mixing of the hydrophobic treatment agent and the toner base particle dispersed solution, a reaction progresses more readily between the hydrophobic treatment agent and the organosilicon polymer contained in the surface layer formed on the toner base particles.

The organic solvent is not particularly limited as long as this can facilitate mixing of the hydrophobic treatment agent and the toner base particle dispersed solution, but specific examples thereof include: alcohols having a short carbon chain, such as methanol, ethanol, 1-propanol, 2-propanol, 1-butanol, 2-butanol, t-butanol and 1-pentanol; ethylene glycol monoalkyl ethers such as ethylene glycol monomethyl ether and ethylene glycol monoethyl ether; and glycols such as methylene glycol and ethylene glycol.

Among the organic solvents listed above, alcohols having a short carbon chain are preferred, and methanol is more preferred.

In order to obtain the organosilicon polymer contained in the surface layer formed on the toner base particles, it is possible to use an organosilicon compound having 3 reactive groups (R₂, R₃ and R₄) in the molecule, excluding R₁ in formula (Y) above (hereinafter referred to as a “trifunctional silane”), or a combination of a plurality of these compounds.

Examples of compounds represented by formula (Y) above include those listed below.

Trifunctional methylsilane compounds such as methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane and methyldiethoxyhydroxysilane.

Trifunctional silane compounds such as ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane and hexyltrihydroxysilane.

Trifunctional phenylsilane compounds such as phenyltrimethoxysilane, phenyltriethoxysilane, phenyltrichlorosilane, phenyltriacetoxysilane and phenyltrihydroxysilane.

Trifunctional vinylsilane compounds such as vinylethoxydimethoxysilane, vinyltrichlorosilane, vinylmethoxydichlorosilane, vinylethoxydichlorosilane, vinyldimethoxychlorosilane, vinylmethoxyethoxychlorosilane, vinyldiethoxychlorosilane, vinyltriacetoxysilane, vinyldiacetoxymethoxysilane, vinyldiacetoxyethoxysilane, vinylacetoxydimethoxysilane, vinylacetoxymethoxyethoxysilane, vinylacetoxydiethoxysilane, vinyltrihydroxysilane, vinylmethoxydihydroxysilane, vinylethoxydihydroxysilane, vinyldimethoxyhydroxysilane, vinylethoxymethoxyhydroxysilane and vinyldiethoxyhydroxysilane.

Trifunctional allylsilane compounds such as allyltrimethoxysilane, allyltriethoxysilane, allyltrichlorosilane, allyltriacetoxysilane and allyltrihydroxysilane.

In the monomer that forms the organosilicon polymer, the content of the organosilicon compound having the structure represented by formula (Y) is preferably 50 mol % or more, more preferably 90 mol % or more, and further preferably 92 mol % or more. By setting the content of the organosilicon compound that satisfies formula (Y) to be 50 mol % or more, it is possible to further improve the environmental stability of the toner.

An organosilicon polymer obtained by additionally using an organosilicon compound having 4 reactive groups in the molecule (a tetrafunctional silane), an organosilicon compound having 3 reactive groups in the molecule (a trifunctional silane), an organosilicon compound having 2 reactive groups in the molecule (a difunctional silane) or an organosilicon compound having 1 reactive group in the molecule (a monofunctional silane) in addition to the organosilicon compound having a structure represented by formula (Y) may be used as long as the advantageous effect of the present invention is not impaired. Examples of such organosilicon compounds include those listed below.

Dimethyldiethoxysilane, tetraethoxysilane, hexamethyldisilazane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropylmethyldiethoxysilane, 3-methacryloxypropyltriethoxysilane, 3-acryloxypropyltrimethoxysilane, 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, 3-phenylaminopropyltrimethoxysilane, 3-anilinopropyltrimethoxysilane, 3-mercaptopropylmethyldimethoxysilane, 3-mercaptopropyltrimethoxysilane, 3-mercaptopropyltriethoxysilane, 3-glycidoxypropyltrimethoxysilane, 3-glycidoxypropylmethyldimethoxysilane, 3-glycidoxypropylmethyldiethoxysilane, hexamethyldisiloxane, tetraisocyanatosilane, methyltriisocyanatosilane, vinyltriisocyanatosilane, vinyltrimethoxysilane, vinyltriethoxysilane and vinyldiethoxymethoxysilane.

The hydrophobic treatment agent used in the third step is not particularly limited, but it is preferable to use a hydrophobic treatment agent that trialkylsilylates a silanol group in the organosilicon polymer, and it is more preferable to use a hydrophobic treatment agent that trimethylsilylates a silanol group in the organosilicon polymer. These hydrophobic treatment agents are highly hydrophobic and are unlikely to be affected by moisture. Monofunctional silanes, hexamethyldisilazane and hexamethyldisiloxane are preferred as this type of hydrophobic treatment agent, and hexamethyldisilazane is more preferred from the perspective of reactivity.

Preferred monofunctional silanes are represented by formula (c) below, and examples thereof include t-butyldimethylchlorosilane, t-butyldimethylmethoxysilane, t-butyldimethylethoxysilane, chlorotrimethylsilane, methoxytrimethylsilane, ethoxytrimethylsilane, triethylmethoxysilane, triethylethoxysilane, tripropylmethoxysilane, tributylmethoxysilane and tripentylmethoxysilane.

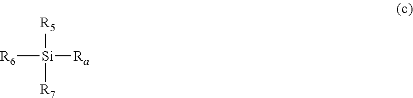

In formula (c), R₅, R₆ and R₇ each independently denote an alkyl group having 1 to 6 carbon atoms or an aryl group, and Ra denotes a halogen atom, a hydroxy group, an acetoxy group or an alkoxy group.

In the fourth step, the toner particles obtained in the third step are washed with water. The toner particles obtained in the third step are preferably recovered before being washed with water.

The method for recovering the toner particles having the surface layer containing the organosilicon polymer is not particularly limited, and a well-known method can be used. A filtration method is preferred from the perspective of being a simple procedure. The filtration method is not particularly limited, and a well-known apparatus such as vacuum filtration, centrifugal filtration or pressure filtration can be selected. A filter paper, filter or filter cloth to be used in the filtration is not particularly limited as long as this can be industrially procured, and should be selected as appropriate according to the type of apparatus being used. In addition, the toner particles can be washed with water by washing with water at the time of filtration. The type of water used in the washing with water is not particularly limited, but use of ion exchanged water is preferred.

In cases where the toner particle has a surface layer containing the organosilicon polymer and the organosilicon polymer contained in the surface layer has been subjected to a hydrophobic treatment, hydrophobic properties increase. In such a case, it was understood the toner particles float in water at the time of washing and washing cannot be sufficiently carried out. Therefore it is preferable to mix the toner particles with an organic solvent such as an alcohol, such as methanol, ethanol, 2-propanol or butanol, place the obtained mixture in a filtration apparatus, allow the toner particles to settle on the bottom of the filtration apparatus, produce a cake of toner particles, and then wash the cake with ion exchanged water. In the present disclosure, washing is carried out until the electrical conductivity of a filtrate obtained by filtering the toner is 1.0 to 2.5 μS/cm.

The amount of silanol groups in the toner particles, as measured by a titration method using potassium hydroxide (hereinafter referred to as KOH), is preferably 0.010 to 0.075 mmol/g, more preferably 0.020 to 0.068 mmol/g, and particularly preferably 0.030 to 0.060 mmol/g.

If the amount of silanol groups in toner particles is 0.075 mmol/g or less, this shows that the amount of silanol groups at the surface of the surface layer containing the organosilicon polymer on the toner particles is low. Silanol groups at the surface of the surface layer containing the organosilicon polymer adsorb moisture in the atmosphere and leak charge.

Furthermore, because ion components that are present in the toner particles, such as OH⁻ and H⁺, have similar structures to silanol groups, it was understood that if both ion components and silanol groups are present, interactions between these lead to further charge leakage. Therefore, the amount of ion components present in the toner particles is reduced if the electrical conductivity mentioned above is 2.5 μS/cm or less, and by making the amount of silanol groups 0.075 mmol/g or less, interactions between ion components and silanol groups are weakened, and it is possible to further suppress charge leakage. Therefore, there is little change in the charge quantity of the toner before and after a copier or printer is in sleep mode, and charge maintaining properties in a high temperature high humidity environment are improved.

If the amount of silanol groups in toner particles is 0.010 mmol/g or more, this shows that an appropriate quantity of silanol groups are present at the surface of the surface layer containing the organosilicon polymer on the toner particles.

Because ion components that are present in the toner particles, such as OH⁻ and H⁺, have similar structures to silanol groups, it was understood that if both ion components and silanol groups are present, interactions between these lead to charging being more readily eased when the toner is excessively charged. Therefore, by reducing the amount of ion components present in toner particles so as to make the electrical conductivity mentioned above 1.0 μS/cm or more and by making the amount of silanol groups 0.010 mmol/g or more, interactions between ion components and silanol groups can be appropriately utilized. As a result, excessive toner charging can be better suppressed when the toner and the magnetic carrier are mixed and charged. Therefore, even in cases where images are outputted for a long period of time in a low temperature low humidity environment or a normal temperature normal humidity environment, the toner exhibits charge stability, and image density, image density uniformity and image quality are improved.

The amount of silanol groups in the toner particle can be controlled by controlling the type of organosilicon polymer, condensation conditions, the amount of hydrophobic treatment to which the organosilicon polymer is subjected, the type of hydrophobic treatment agent, and hydrophobic treatment conditions.

In a wettability test of the toner with a mixed methanol/water solvent, the methanol concentration at which the transmittance of light having a wavelength of 780 nm is 50% is preferably 35.0 to 70.0 vol %, more preferably 40.0 to 68.0 vol %, and further preferably 45.0 to 65.0 vol %.

If the methanol concentration mentioned above is 35.0 vol % or more, this shows that the toner is highly hydrophobic. Therefore, there is less susceptibility to moisture, and even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

If the methanol concentration mentioned above is 70.0 vol % or less, this shows that the toner is not excessively hydrophobic. Therefore, it is possible to suppress excessive toner charging. Therefore, even in cases where images are outputted for a long period of time in a low temperature low humidity environment or a normal temperature normal humidity environment, the toner exhibits charge stability, and image density, image density uniformity and image quality are improved.

In a wettability test of the toner with a mixed methanol/water solvent, the methanol concentration at which the transmittance of light having a wavelength of 780 nm is 50% can be controlled by controlling the type of organosilicon polymer, condensation conditions, the amount of hydrophobic treatment to which the organosilicon polymer is subjected, the type of hydrophobic treatment agent, and hydrophobic treatment conditions.

In a chart obtained by measuring the amount of tetrahydrofuran-insoluble matter in the toner particle by ²⁹Si-NMR, a ratio of an area of a peak derived from a silicon atom assigned to a structure represented by formula (a) below relative to a total area of peaks derived from all silicon atoms comprised in the organosilicon polymer is preferably 0.005 to 0.080, and more preferably 0.010 to 0.050.

If the ratio of the area of a peak derived from a silicon atom assigned to a structure represented by formula (a) below is 0.005 or more, this shows that an appropriate amount of trialkylsilyl groups are present in the organosilicon polymer. If an appropriate amount of trialkylsilyl groups are present, the toner particle is unlikely to be affected by moisture because trialkylsilyl groups are hydrophobic. Therefore, even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

If the ratio of the area of a peak derived from a silicon atom assigned to a structure represented by formula (a) below is 0.080 or less, this shows that the amount of trialkylsilyl groups present in the organosilicon polymer is not excessively high. As a result, it is possible to suppress excessive toner charging. Therefore, even in cases where images are outputted for a long period of time in a low temperature low humidity environment or a normal temperature normal humidity environment, the toner exhibits charge stability, and image density, image density uniformity and image quality are improved.

The ratio of the area of a peak derived from a silicon atom assigned to a structure represented by formula (a) below can be controlled by controlling the amount of hydrophobic treatment to which the organosilicon polymer is subjected, the type of hydrophobic treatment agent, and hydrophobic treatment conditions.

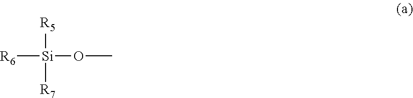

In formula (a), R₅, R₆ and R₇ each independently denote an alkyl group having 1 to 6 carbon atoms.

The content of the organosilicon polymer in the toner particle is preferably 4.0 to 30.0 mass %, and more preferably 5.0 to 20.0 mass %.

If the content of the organosilicon polymer in the toner particle falls within the range mentioned above, the toner particle surface layer can be uniformly coated. Therefore, durable stability is improved, and even in cases where images are outputted for a long period of time in a low temperature low humidity environment or a normal temperature normal humidity environment, the toner exhibits charge stability, and image density, image density uniformity and image quality are improved.

The content of the organosilicon polymer in the toner particle can be controlled by controlling the raw material composition when the organosilicon polymer is produced, reaction conditions such as reaction temperature, reaction time, reaction solvent and pH, and so on, and the content of the organosilicon polymer can be measured using X-Ray fluorescence analysis such as that described later.

The organosilicon polymer has a structure in which a silicon atom and an oxygen atom are alternately bonded to each other, and in a chart obtained by measuring the amount of tetrahydrofuran-insoluble matter in the toner particle by ²⁹Si-NMR, a ratio of an area of a peak derived from a silicon atom assigned to a structure represented by formula (b) below relative to a total area of peaks derived from all silicon atoms comprised in the organosilicon polymer is preferably 0.900 to 1.000, and more preferably 0.920 to 1.000.

If the ratio of the area of a peak derived from a silicon atom assigned to a structure represented by formula (b) below relative to the total area of peaks derived from all silicon atoms comprised in the organosilicon polymer falls within the range mentioned above, the organosilicon polymer contained in the surface layer formed on the toner base particles can be more readily subjected to a hydrophobic treatment, and the effect of the hydrophobic treatment is increased. Therefore, there is less susceptibility to moisture, and even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

The ratio of the area of a peak derived from a silicon atom assigned to a structure represented by formula (b) can be controlled through selection of a silicon compound and by controlling the mixing ratio of the silicon compound.

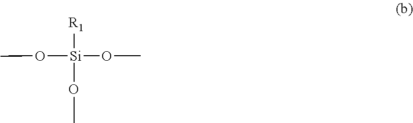

In formula (b), R₁ denotes an alkyl group having 1 to 6 carbon atoms or an aryl group.

The organosilicon polymer has a structure in which a silicon atom and an oxygen atom are alternately bonded to each other, and in a chart obtained by measuring an amount of tetrahydrofuran-insoluble matter in the toner particle by ²⁹Si-NMR, a ratio (ST3/ST2) of an area (ST3) of a peak derived from a T3 unit structure relative to an area (ST2) of a peak derived from a T2 unit structure in an area of peaks derived from silicon atoms assigned to a structure represented by formula (b) above is 3.0 to 4.5, and more preferably 3.2 to 4.0.

A T3 unit structure is a structure in which 3 oxygens that are bonded to another Si atom (hereinafter referred to as crosslinking oxygens) are bonded to a Si atom, and a T2 unit structure is a structure in which 2 crosslinking oxygens are bonded to a Si atom and 1 oxygen which is not crosslinking oxygen is bonded to a Si atom. In many cases, a hydroxy group is used as a functional group to form a bond of oxygen which is not crosslinking oxygen. Therefore, T2 unit structures tend to have higher amount of hydroxyl groups, and a higher amount of T2 structures leads to susceptibility to moisture.

If the value of ST3/ST2 is 3.0 or more, this shows that the amount of T3 structures is high. Therefore, there is less susceptibility to moisture, and even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

If the value of ST3/ST2 is 4.5 or less, this shows that an appropriate amount of T2 unit structures are present. If an appropriate amount of T2 unit structures are present, an appropriate amount of silanol groups, which are reaction sites that react with the hydrophobic treatment agent, are present when the organosilicon polymer contained in the surface layer formed on the toner base particles is subjected to the hydrophobic treatment. As a result, the effect of the hydrophobic treatment performed on the organosilicon polymer contained in the surface layer formed on the toner base particles is more readily achieved. Therefore, there is less susceptibility to moisture, and even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

The value of ST3/ST2 can be controlled through selection of a silicon compound and by controlling the mixing ratio of the silicon compound.

Binder Resin

The toner particle comprises a binder resin.

The binder resin used in the toner particle is not particularly limited, and polymers such as those listed below can be used. Homopolymers of styrene and substituted styrene compounds, such as polystyrene, poly-p-chlorostyrene and poly(vinyl toluene); styrene-based copolymers such as styrene-p-chlorostyrene copolymers, styrene-vinyl toluene copolymers, styrene-vinyl naphthalene copolymers, styrene-acrylic acid ester copolymers, styrene-methacrylic acid ester copolymers, styrene-a-chloromethyl methacrylate copolymers, styrene-a-chloromethyl methacrylate copolymers, styrene-vinyl methyl ether copolymers, styrene-vinyl ethyl ether copolymers, styrene-vinyl methyl ketone copolymers and styrene-acrylonitrile-indene copolymers; poly(vinyl chloride), phenolic resins, natural resin-modified phenolic resins, natural resin-modified maleic acid resins, acrylic resins, methacrylic resins, poly(vinyl acetate) resins, silicone resins, polyester resins, polyurethane resins, polyamide resins, furan resins, epoxy resins, xylene resins, poly(vinyl butyral) resins, terpene resins, cumarone-indene resins and petroleum-based resins.

The binder resin preferably comprises an amorphous resin and a crystalline resin.

The crystalline resin preferably has a first monomer unit represented by formula (x) below.

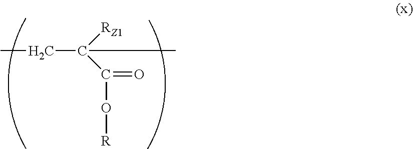

In formula (x), R_{Z1} denotes a hydrogen atom or a methyl group, and R denotes an alkyl group having 18 to 36 (preferably 18 to 30) carbon atoms. In addition, the alkyl group preferably has a straight chain structure.

The crystalline resin preferably has a first monomer unit represented by formula (x). Because the crystalline resin has a long chain alkyl group having 18 to 36 carbon atoms, interactions occur between the organosilicon polymer having an alkyl group and the binder resin that contains the crystalline resin, and adhesive properties are improved. As a result, durability is improved. In addition, because the crystalline resin is highly hydrophobic, the toner is unlikely to be affected by moisture. Therefore, even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

The first monomer unit represented by formula (1) is preferably a monomer unit derived from at least one type selected from the group consisting of (meth)acrylic acid esters having an alkyl group with 18 to 36 carbon atoms.

Examples of (meth)acrylic acid esters having an alkyl group with 18 to 36 carbon atoms include (meth)acrylic acid esters having a straight chain alkyl group with 18 to 36 carbon atoms [stearyl (meth)acrylate, nonadecyl (meth)acrylate, eicosyl (meth)acrylate, heneicosyl (meth)acrylate, behenyl (meth)acrylate, lignoceryl (meth)acrylate, ceryl (meth)acrylate, octacosyl (meth)acrylate, myricyl (meth)acrylate, dotriacontyl (meth)acrylate, and the like] and (meth)acrylic acid esters having a branched chain alkyl group with 18 to 36 carbon atoms [2-decyltetradecyl (meth)acrylate, and the like].

The monomer that forms the first monomer unit may be a single monomer or a combination of two or more types.

The crystalline resin may contain another monomer unit in addition to the first monomer unit represented by formula (1).

From the perspective of durability, the melting point of the crystalline resin is preferably 40 to 80° C., and more preferably 45 to 70° C.

The content of the first monomer unit in the crystalline resin is preferably 20 to 100 mass %, more preferably 30 to 80 mass %, and further preferably 40 to 70 mass %, relative to the total mass of all monomer units in the crystalline resin. Durability is good within this range. In addition, the content of the first monomer unit in the crystalline resin can be measured using NMR and so on.

A well-known amorphous resin can be used as the amorphous resin. Examples thereof include the types listed below.

Poly(vinyl chloride), phenol resins, natural resin-modified phenol resins, natural resin-modified maleic acid resins, poly(vinyl acetate) resins, silicone resins, polyester resins, polyurethane resins, polyamide resins, furan resins, epoxy resins, xylene resins, poly(vinyl butyral) resins, terpene resins, coumarone-indene resins, petroleum-based resins and vinyl-based resins. Of these, the second resin preferably contains at least one type of resin selected from the group consisting of a hybrid resin in which a vinyl-based resin and a polyester resin are bound to each other, a polyester resin and a vinyl-based resin.

In addition, from the perspective of durability, the softening point Tm of the second resin, which is an amorphous resin, in the binder resin is preferably 100° C. or higher.

Colorant

The toner particle may contain a colorant. Examples of the colorant include those listed below. Examples of black colorants include carbon black; and materials that are colored black through use of yellow colorants, magenta colorants and cyan colorants. The colorant may be a single pigment, but using a colorant obtained by combining a dye and a pigment and improving the clarity is more preferred from the perspective of full color image quality.

Examples of a pigment for a magenta toner include the following. C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, 282; C. I. Pigment Violet 19; C. I. Vat Red 1, 2, 10, 13, 15, 23, 29, 35.

Examples of a dye for a magenta toner include the following. Oil-soluble dyes such as C. I. Solvent Red 1, 3, 8, 23, 24, 25, 27, 30, 49, 81, 82, 83, 84, 100, 109, 121; C. I. Disperse Red 9; C. I. Solvent Violet 8, 13, 14, 21, 27; C. I. Disperse Violet 1, Basic dyes such as C. I. Basic Red 1, 2, 9, 12, 13, 14, 15, 17, 18, 22, 23, 24, 27, 29, 32, 34, 35, 36, 37, 38, 39, 40; C. I. Basic Violet 1, 3, 7, 10, 14, 15, 21, 25, 26, 27, 28.

Examples of a pigment for a cyan toner include the following. C. I. Pigment Blue 2, 3, 15:2, 15:3, 15:4, 16, 17; C. I. Vat Blue 6; C. I. Acid Blue 45, a copper phthalocyanine pigment having a phthalocyanine skeleton substituted with 1 to 5 phthalimidomethyl groups. Examples of a dye for a cyan toner include C. I. Solvent Blue 70.

Examples of a pigment for a yellow toner include the following. C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185; C. I. Vat Yellow 1, 3, 20. Examples of a dye for a yellow toner include C. I. Solvent Yellow 162.

The content of the colorant is preferably 0.1 to 30.0 parts by mass relative to 100 parts by mass of the binder resin.

Release Agent

The toner particle preferably contains a release agent. Examples of the release agent include those listed below. Hydrocarbon-based waxes such as low molecular weight polyethylene, low molecular weight polypropylene, alkylene copolymers, microcrystalline waxes, paraffin waxes and Fischer Tropsch waxes; oxides of hydrocarbon-based waxes, such as oxidized polyethylene waxes, and block copolymers thereof; waxes comprising mainly fatty acid esters, such as carnauba wax; and waxes obtained by partially or wholly deoxidizing fatty acid esters, such as deoxidized carnauba wax.

Further examples include the types listed below. Saturated straight chain fatty acids such as palmitic acid, stearic acid and montanic acid; unsaturated fatty acids such as brassidic acid, eleostearic acid and parinaric acid; saturated alcohols such as stearyl alcohol, aralkyl alcohols, behenyl alcohol, carnaubyl alcohol, ceryl alcohol and melissyl alcohol; polyhydric alcohols such as sorbitol; esters of fatty acids such as palmitic acid, stearic acid, behenic acid and montanic acid and alcohols such as stearyl alcohol, aralkyl alcohols, behenyl alcohol, carnaubyl alcohol, ceryl alcohol and melissyl alcohol; fatty acid amides such as linoleic acid amide, oleic acid amide and lauric acid amide; saturated fatty acid bisamides such as methylene bis-stearic acid amide, ethylene bis-capric acid amide, ethylene bis-lauric acid amide and hexamethylene bis-stearic acid amide; unsaturated fatty acid amides such as ethylene bis-oleic acid amide, hexamethylene bis-oleic acid amide, N,N′-dioleyladipic acid amide and N,N′-dioleylsebacic acid amide; aromatic bisamides such as m-xylene bis-stearic acid amide and N,N′-distearylisophthalic acid; fatty acid metal salts (commonly known as metal soaps) such as calcium stearate, calcium laurate, zinc stearate and magnesium stearate; waxes obtained by grafting vinyl monomers such as styrene and acrylic acid onto aliphatic hydrocarbon-based waxes; partial esters of fatty acids and polyhydric alcohols, such as behenic acid monoglyceride; and hydroxyl group-containing methyl ester compounds obtained by hydrogenating plant-based oils and fats.

Of these, a hydrocarbon wax is preferred as the release agent from the perspective of dispersibility of the release agent. By using a hydrocarbon wax, the release agent is more readily dispersed in the toner. In addition, because alkyl groups in the hydrocarbon wax and alkyl groups in the organosilicon polymer interact with each other, adhesive properties and durability are improved. In addition, because the hydrocarbon wax is highly hydrophobic, it is possible to further increase the hydrophobic properties of the toner. Therefore, even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

The content of the release agent is preferably 2.0 to 30.0 parts by mass relative to 100.0 parts by mass of the binder resin.

The toner particle preferably contains a release agent dispersing agent in addition to the release agent. In order to improve the dispersibility of the release agent in the binder resin, it is preferable to add a resin that contains both a moiety having a similar polarity to the release agent component and a moiety having a similar polarity to the resin as a release agent dispersing agent. More specifically, a styrene-acrylic-based resin that has been graft-modified by a hydrocarbon compound is preferred. By incorporating the release agent dispersing agent in the toner particle, the release agent can be more readily dispersed in the toner and the hydrophobic properties of the toner can be further increased. In addition, by improving the dispersibility of the release agent, adhesion to the organosilicon polymer is improved and durability is also improved. Therefore, even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

The toner particle preferably comprises the release agent, and in an FT-IR spectrum obtained by measuring the toner particle using an ATR method, using Ge as an ATR crystal and at an infrared light incident angle of 45°, when Pa denotes a maximum absorption peak intensity of a value obtained by subtracting the average value of the absorption intensity at 3050 cm⁻¹ and 2600 cm⁻¹ from a maximum value of absorption peak intensity within a wavelength range 2843 to 2853 cm⁻¹, and Pb denotes a maximum absorption peak intensity of a value obtained by subtracting an average value of an absorption intensity at 1800 cm⁻¹ and 1650 cm⁻¹ from a maximum value of absorption peak intensity within a wavelength range 1713 to 1723 cm⁻¹, then Pa and Pb preferably satisfy formula (3) below.

0.150≤Pa/Pb≤0.400 (3)

In addition, Pa and Pb more preferably satisfy formula (3′) below.

0.200≤Pa/Pb≤0.300 (3′)

Pa indicates the relative amount of the release agent at the toner particle surface. The maximum value of absorption peak intensity within the wavelength range 2843 to 2853 cm⁻¹ indicates the amount of absorption derived from (symmetric) stretching vibrations of —CH₂— derived mainly from the release agent.

Pb indicates the relative amount of the binder resin at the toner particle surface. The maximum value of absorption peak intensity within the wavelength range 1713 to 1723 cm⁻¹ indicates the amount of absorption derived from stretching vibrations of —CO-derived mainly from the binder resin.

When determining Pa, the reason for subtracting the average value of the absorption intensity at 3050 cm⁻¹ and 2600 cm⁻¹ from the maximum value of absorption peak intensity within the wavelength range 2843 to 2853 cm⁻¹ is to eliminate baseline effects and calculate a true peak intensity. Because there are no absorption peaks close to 3050 cm⁻¹ and 2600 cm⁻¹, by calculating the average value at these two points, a baseline intensity can be calculated.

When determining Pb, the reason for subtracting the average value of the absorption intensity at 1800 cm⁻¹ and 1650 cm⁻¹ from the maximum value of absorption peak intensity within the wavelength range 1713 to 1723 cm⁻¹ is the same as that given for determining Pa.

If Pa and Pb satisfy formula (3) above, this shows that the release agent is present close to the surface layer of the toner particle. Therefore, adhesion of the organosilicon polymer is improved, and durability is also improved. In addition, the hydrophobic properties of the toner can be further increased. Therefore, even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

Examples of methods for causing the release agent to be present close to the surface layer of the toner include methods involving adjusting the amount of the release agent or the release agent dispersing agent, and methods involving subjecting the toner particle to a heat treatment.

Charge Control Agent

The toner particle may contain a charge control agent if necessary. A well-known charge control agent can be used, but an aromatic carboxylic acid metal compound is particularly preferred from the perspectives of being colorless, toner charging speed being rapid, and being able to stably maintain a certain degree of charge quantity.

Examples of negative type charge control agents include metal salicylate compounds, metal naphthoate compounds, metal dicarboxylate compounds, polymer type compounds having a sulfonic acid or carboxylic acid in a side chain, polymer type compounds having a sulfonic acid salt or sulfonic acid ester in a side chain, polymer type compounds having a carboxylic acid salt or carboxylic acid ester in a side chain, boron compounds, urea compounds, silicon compounds and calixarenes.

Examples of positive charge control agents include quaternary ammonium salts, polymer compounds having a quaternary ammonium salt in a side chain, guanidine compounds and imidazole compounds. The charge control agent may be internally or externally added to the toner particle. The added quantity of the charge control agent is preferably 0.2 to 10.0 parts by mass relative to 100.0 parts by mass of the binder resin.

Inorganic Fine Particles

The toner may contain inorganic fine particles if necessary. The inorganic fine particles may be internally added to the toner particle or mixed as an external additive with the toner particle. In cases where inorganic fine particles are contained as an external additive, inorganic fine particles such as silica fine particles, titanium oxide fine particles and aluminum oxide fine particles are preferred. These inorganic fine particles are preferably hydrophobized by means of a hydrophobizing agent such as a silane compound, a silicone oil or a mixture of these.

Inorganic fine particles having a specific surface area of 50 to 400 m²/g are preferred as an external additive for improving fluidity. In order to achieve both improved fluidity and stable durability, it is possible to use inorganic fine particles whose specific surface area falls within the range mentioned above in combination with the external additive for the toner.

The inorganic fine particles are preferably used at a quantity of 0.1 to 10.0 parts by mass relative to 100.0 parts by mass of the toner particle. If the range mentioned above is satisfied, a charge-stabilizing effect tends to be achieved.

Two Component Developer

In the present disclosure, the toner is mixed with a magnetic carrier and used as a two component developer in order to supply stable images over a long period of time.

The magnetic carrier comprises a magnetic carrier core particle and a resin coat layer formed on a surface of the magnetic carrier core particle. Because the magnetic carrier comprises the resin coat layer, charge stability is good when images are outputted over a long period of time.

Conventional magnetic carrier core particles, such as ferrite or magnetite, can be used as the magnetic carrier core particle. In addition, it is also possible to use binder type magnetic carrier core particles in which a magnetic powder is dispersed in a resin.

A resin containing fluorine element, a resin containing silicon element or a compound containing nitrogen element can be advantageously used as the resin used in the resin coat layer. The resin coat layer does not necessarily need to coat the entire surface of the magnetic carrier core particle, and there may be portions where a part of the magnetic carrier core particle is exposed.

By forming the resin coat layer on the surface of the magnetic carrier core particle, it is possible to increase the charge quantity of the two component developer in high temperature high humidity environments in particular and improve environmental stability.

The method for forming the resin coat layer is not particularly limited, but examples thereof include coating methods such as dipping methods, spraying methods, brush coating methods, dry methods and fluidized beds.

The resin coat layer formed on the surface of the magnetic carrier core particle can be confirmed by means of elemental analysis of the resin coat layer on the surface of the magnetic carrier core using ESCA, or observations of a cross section of the magnetic carrier using a transmission electron microscope (TEM) (at a magnification ratio of 50,000 times).

The magnetic carrier preferably comprises: a resin-filled magnetic core particle having a porous magnetic particle and a resin present in pores of the porous magnetic particle; and a resin coat layer present at a surface of the resin-filled magnetic core particle, and the resin coat layer preferably comprises a copolymer of at least: a (meth)acrylic acid ester having an alicyclic hydrocarbon group; and another (meth)acrylic monomer.

Because the carrier is a porous magnetic particle, unevenness is formed on the surface, charge-imparting capacity is stable, and an appropriate level of charge-easing occurs.

In addition, because the magnetic carrier is a resin-filled magnetic core particle and the surface of the resin-filled magnetic core particle has a prescribed resin coat layer, the surface of the toner of the present disclosure and the surface of the magnetic carrier have similar structures to each other. Therefore, charge-providing performance is stable and it is possible to prevent the toner from becoming excessively charged. Therefore, it was understood that an appropriate degree of charge leakage from the carrier occurs in low temperature low humidity environments and normal temperature normal humidity environments. Therefore, even in cases where images are outputted for a long period of time in a low temperature low humidity environment or a normal temperature normal humidity environment, the toner exhibits charge stability, and image density, image density uniformity and image quality are improved.

Examples of (meth)acrylic acid esters having an alicyclic hydrocarbon group include cyclopropyl acrylate, cyclobutyl acrylate, cyclopentyl acrylate, cyclohexyl acrylate, cycloheptyl acrylate dicyclopentenyl acrylate, dicyclopentanyl acrylate, cyclobutyl methacrylate, cyclopentyl methacrylate, cyclohexyl methacrylate, cycloheptyl methacrylate, dicyclopentenyl methacrylate and dicyclopentanyl methacrylate. It is possible to select and use one of these, or two or more types thereof.

In addition, examples of the other (meth)acrylic monomer include methyl acrylate, methyl methacrylate, ethyl acrylate, ethyl methacrylate, butyl (n-butyl, sec-butyl, iso-butyl or tert-butyl; the same applies hereinafter) acrylate, butyl methacrylate, 2-ethylhexyl acrylate, 2-ethylhexyl methacrylate, acrylic acid and methacrylic acid. It is possible to select and use one of these, or two or more types thereof.

The concentration of the toner in the two component developer is preferably 2 to 15 mass %, and more preferably 4 to 13 mass %.

A publicly known method can be advantageously used as the method for producing the two component developer, but it is preferable to use a method which has: a step for producing a magnetic carrier core particle; a resin coating step in which the magnetic carrier core particle is coated with a resin to form a magnetic carrier; a step for producing a toner particle; and a step for mixing the magnetic carrier with a toner having the toner particle.

In addition, a publicly known method can be advantageously used as the method for producing the toner particle, but use of the method described below is preferred. That is, it is preferable to use the method described below in order to produce the two component developer described above.

A method for producing the two component developer described above, wherein the method comprises:
a step for mixing the magnetic carrier and the toner having the toner particle,
a step for producing the toner particle comprises:
a first step for obtaining a hydrolyzate of an organo silicon compound having a structure represented by formula (Y) below;
a second step for mixing the hydrolyzate obtained in the first step, toner base particles dispersed in an aqueous medium, and an alkaline aqueous medium, subjecting at least a part of the hydrolyzate to a polycondensation reaction, and forming a surface layer comprising an organosilicon polymer on the toner base particles;
a third step for subjecting the organosilicon polymer comprised in the surface layer formed on the toner base particles to a hydrophobic treatment, and then obtaining a toner particle comprising an organosilicon polymer; and
a fourth step for washing the toner particles obtained in the third step with water.

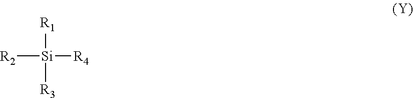

In formula (Y), R₁ denotes a hydrocarbon group having 1 to 6 carbon atoms or an aryl group, and R₂, R₃ and R₄ each independently denote a halogen atom, a hydroxy group, an acetoxy group or an alkoxy group.

Methods for Producing Toner Base Particle, Toner Particle and Toner

The toner base particle of the present disclosure can be produced using a conventional well-known toner production method, such as an emulsion aggregation method, a melt kneading method or a dissolution suspension method, and is not particularly limited, but a melt kneading method is preferred. In a case where the toner base particle is produced using a melt kneading method, a toner base particle having a prescribed particle diameter is obtained by melt kneading a mixture obtained by mixing raw materials, cooling, pulverizing and classifying. In this case, it is essential to disperse the toner base particles in an aqueous medium.

When producing the toner base particle of the present disclosure, it is preferable to include a melt kneading step for melt kneading a mixture containing a binder resin and a release agent. By including said melt kneading step, it is possible to finely disperse the release agent in the toner base particles. Because the release agent is highly hydrophobic, a toner obtained using this type of toner base particle is unlikely to be affected by moisture. Therefore, even in cases where images are outputted for a long period of time in a low temperature low humidity environment or a normal temperature normal humidity environment, the toner exhibits charge stability, and image density, image density uniformity and image quality are improved. In addition, there is little change in the charge quantity of the toner before and after a copier or printer is in sleep mode, and charge maintaining properties in a high temperature high humidity environment are improved.

An explanation will now be given of a toner production procedure using a melt kneading method.

In the raw material mixing step, prescribed quantities of, for example, a binder resin, a release agent, a release agent dispersing agent, a colorant and, if necessary, other components such as a charge control agent, are weighed out as raw materials that constitute the toner base particle, and then blended and mixed. Examples of the mixing device include a double cone mixer, a V type mixer, a drum type mixer, a supermixer, a Henschel mixer, a Nauta mixer and a Mechano Hybrid (produced by Nippon Coke and Engineering Co., Ltd.).

Next, the mixed materials are melt kneaded so as to disperse the wax and the like in the binder resin. In this melt kneading step, a batch type kneader, such as a pressurizing kneader or Banbury mixer, or a continuous type kneader can be used, and single screw and twin screw extruders have become mainstream from the perspective of enabling continuous production. Examples thereof include KTK type twin screw extruders (produced by Kobe Steel Ltd.), TEM type twin screw extruders (produced by Shibaura Machine Co., Ltd.), PCM kneaders (produced by Ikegai Corp.), twin screw extruders (produced by KCK), co-kneaders (produced by Buss) and Kneadex (produced by Nippon Coke & Engineering Co., Ltd.). Furthermore, a resin composition obtained by melt kneading is rolled using a 2-roll roller or the like, and may be cooled by means of water or the like in a cooling step.

Next, the cooled resin composition is pulverized to a required particle diameter in a pulverizing step. In the pulverizing step, the cooled resin composition is coarsely pulverized using, for example, a pulverizer such as a crusher, a hammer mill or a feather mill, and then finely pulverized using, for example, a Kryptron system (produced by Kawasaki Heavy Industries, Ltd.), a Super Rotor (produced by Nisshin Engineering), a Turbo Mill (produced by Turbo Kogyo), or an air jet type fine pulverizer.

Next, toner base particles are obtained by classification by means of a classifier or sieving machine such as an inertial classification type elbow jet (produced by Nittetsu Mining Co., Ltd.), a centrifugal classification type Turboplex (produced by Hosokawa Micron Corp.), a TSP separator (produced by Hosokawa Micron Corp.) or a Faculty (produced by Hosokawa Micron Corp.) if necessary.

A surface layer containing the organosilicon polymer is formed on the obtained toner base particles using the method described above, and the organosilicon polymer contained in the surface layer formed on the toner base particles is then subjected to a hydrophobic treatment using the method described above.

Other external additives are then blended if necessary to obtain a toner. The toner particles and external additives can be mixed using a mixing device such as a double cone mixer, a V type mixer, a drum type mixer, a supermixer, a Henschel mixer, a Nauta mixer, a Mechano Hybrid (produced by Nippon Coke and Engineering Co., Ltd.) or a Nobilta (produced by Hosokawa Micron Corp.).

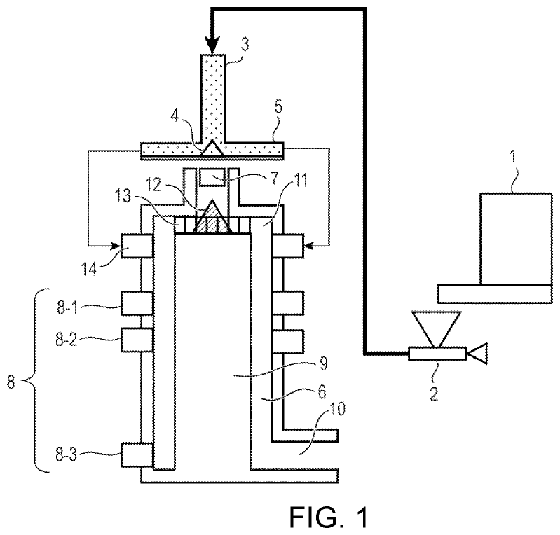

In order to control the Pa/Pb ratio of the toner particle, the toner base particles may be heat treated before the surface layer containing the organosilicon polymer is formed on the toner base particles. The heat treatment can be carried out by means of a hot air current using, for example, a heat treatment apparatus shown in FIG. 1.

The heat treatment apparatus has: a treatment chamber 6 for heat treating the toner base particles; a toner base particle supply means for supplying the toner base particles to the treatment chamber 6; a hot air current supply means 7 for supplying a hot air current used for heat treating the toner base particles supplied from the toner base particle supply means; and a recovery means 10 for discharging the heat treated toner base particles out of the treatment chamber 6 from a discharge port provided in the treatment chamber 6, and recovering the discharged toner base particles.

The heat treatment apparatus shown in FIG. 1 also has a regulation means 9 as a cylindrical component, and the treatment chamber 6 has a cylindrical shape that covers the outer periphery of the regulation means 9. The hot air current supply means 7 is provided at one edge of the cylindrical shape of the treatment chamber 6 so that the hot air current flows while rotating around the treatment chamber 6 having a cylindrical shape. In addition, the toner base particle supply means is constituted from a plurality of supply tubes 5 provided at the outer periphery of the treatment chamber 6.

Furthermore, the discharge port provided in the treatment chamber 6 is provided at the periphery of the treatment chamber 6 at the opposite end of the chamber from the side on which the hot air current supply means 7 is provided so as to be present as an extension in the direction of rotation of the toner base particles. An explanation will now be given of a heat treatment carried out using a heat treatment apparatus having a configuration such as that described above.

A fixed amount of toner base particles supplied from a raw material quantitative supply means 1 are fed to an inlet tube 3 disposed vertically above a raw material metered supply means 1 by means of a compressed gas regulated by a compressed gas flow rate regulation means 2. A mixture that passes through the inlet tube is uniformly dispersed by a conical protruding component 4 provided in the center of the raw material metered supply means 1, is then fed to supply tubes 5 that extend in a radial manner in eight directions, and is then fed to the treatment chamber 6, in which a heat treatment is carried out.

At this point, the flow of the mixture supplied to the treatment chamber 6 is regulated by a regulation means 9 which is provided in the treatment chamber 6 and is used to regulate the flow of the mixture. Therefore, the mixture supplied to the treatment chamber is subjected to the heat treatment while being swirled in the treatment chamber 6, and then cooled.

Heat, which is used to heat treat the supplied mixture, is supplied from a hot air current supply means 7, partitioned by a partitioning component 12, and swirled and introduced in a spiral manner into the treatment chamber 6 by means of a swirling component 13 that is used to swirl the hot air current. In this configuration, the swirling component 13 that is used to swirl the hot air current has a plurality of blades, and swirling of the hot air current can be controlled by the number and angle of these blades. The hot air current is supplied from a hot air current supply means outlet 11.

The heat treated toner base particles are cooled by means of a cold air current supplied from cold air current supply means 8 (cold air current supply means 8-1, cold air current supply means 8-2 and cold air current supply means 8-3).

Next, the cooled toner base particles are recovered by a recovery means 10 located at the bottom of the treatment chamber. Moreover, a blower (not shown) is provided before the recovery means, and a configuration in which suction conveying occurs is formed as a result.

In addition, a powder particle supply port 14 is provided in such a way that the swirling direction of the supplied mixture is the same as the swirling direction of the hot air current, and the recovery means 10 of the heat sphering treatment apparatus is also provided at the outer periphery of the treatment chamber so that the swirling direction of the swirled powder particles is maintained. Furthermore, the apparatus is configured so that the cold air current supplied from the cold air current supply means 8 is supplied from a horizontal and tangential direction from the outer periphery of the apparatus to the inner peripheral surface thereof.

Methods for measuring various physical properties will now be explained. Separation of External Additive Particles and Toner Particles from Toner

Various physical properties can be measured using toner particles separated from the toner using the following method. A concentrated sucrose solution is prepared by adding 200 g of sucrose (available from Kishida Chemical Co., Ltd.) to 100 mL of ion exchanged water and dissolving the sucrose while immersing in hot water. A dispersed solution is prepared by placing 31 g of the concentrated sucrose solution and 6 mL of Contaminon N (a 10 mass % aqueous solution of a neutral detergent for cleaning precision measurement equipment, which has a pH of 7 and comprises a non-ionic surfactant, an anionic surfactant and an organic builder, produced by Wako Pure Chemical Industries, Ltd.) in a centrifugal separation tube. 1 g of toner is added to this dispersed solution and lumps of the toner are broken into smaller pieces using a spatula or the like.

The centrifugal separation tube is shaken for 20 minutes at a rate of 350 reciprocations per minute using a shaker (a “KM Shaker” (model: V.SX) produced by Iwaki Sangyo Co., Ltd.). Following the shaking, the solution is transferred to a (50 mL) swing rotor glass tube and subjected to centrifugal separation for 30 minutes at a speed of 3500 rpm using a centrifugal separator.

Because the toner is present in the uppermost layer and the external additive is present in the lower aqueous solution side layer in the glass tube following the centrifugal separation, toner particles in the uppermost layer are collected. If necessary, the centrifugal separation is repeated, and once sufficient separation has been achieved, the dispersed solution is dried and the toner particles are collected.

Method for Separating Toner and Carrier from Two Component Developer

The carrier and the toner are separated using an electric field separation type charge measurement apparatus produced by Etowas Co., Ltd.

The two component developer is supported at an inner sleeve rotational speed of 100 rpm. Under the conditions of a voltage of 3 kV, a two component developer amount of 1 g, a time of 60 seconds and a gap between an inner sleeve and an outer sleeve of 3 mm, the toner and the carrier are separated, and toner attached to the inside of the outer sleeve is recovered.

Method for Measuring Electrical Conductivity of Filtrate Obtained by Filtering Off Toner

The electrical conductivity of a filtrate obtained by filtering off the toner is measured using an electrical conductivity meter (a waterproof portable electrical conductivity meter; AS710 produced by As One Corporation).

1 g of toner and 99 g of ion exchanged water are weighed out into a 200 mL bottle so that the concentration of the toner is 1.0 mass %, and a lid is then attached to the bottle. The contents of the bottle are then shaken for 1 minute at a shaking speed of 200 rpm using a shaker (YS-8D produced by Yayoi Co., Ltd.) so as to mix the toner and the ion exchanged water and obtain a toner mixture liquid.

The toner mixture liquid is then subjected to suction filtration so as to obtain a filtrate from which the toner has been filtered off, and the electrical conductivity of the filtrate is then measured. Measurements are carried out in a normal temperature normal humidity environment at a temperature of 23° C. and a relative humidity of 50%.

Method for Measuring Carbon Concentration, Oxygen Concentration and Silicon Concentration at Toner Particle Surface Using ESCA

A method for measuring the carbon concentration, oxygen concentration and silicon concentration at the toner particle surface using ESCA is as follows.

The ESCA apparatus and measurement conditions are as shown below.
Apparatus: Quantum 2000 (produced by Ulvac-Phi)
X-Ray source: monochromated Al-Kα
Sample measurement range: diameter 100 μm
Photoelectron capture angle: 45°
X-Rays: 50 μm, 12.5 W, 15 kV
Raster: 300 μm×200 μm
Pass Energy: 46.95 eV
Step Size: 0.200 eV
Neutralizing electron gun: 20 μA, 1 V, Ar ion gun: 7 mA, 10 V
Number of sweeps: C 20 times, O 10 times, Si 15 times

Measurement principles are such that photoelectrons are generated using the X-Ray source and energy is measured on the basis of chemical bonds inherent in substances.

Surface atom concentrations (atom %) are calculated from peak intensities of measured elements using relative sensitivity factors provided by PHI.

Toner particles to be measured may be toner particles obtained by separating a toner from a two component developer using the method described above and then separating toner particles from the toner using the method described above.

Method for Measuring the Amount of Silanol Groups in Toner Particle by Means of Titration Method Using KOH

The amount of silanol groups in the toner particle is measured using a method obtained by modifying the Sears method, which is a method for quantifying silanol groups.

### Preparation of Measurement Liquid

0.5 g of toner particles and 25.0 g of ethanol are placed in a 200 mL beaker, the beaker is shaken by hand, and the toner particles are soaked in the ethanol. Next, 75.0 g of a 20% aqueous solution of NaCl is added, and the toner particles are dispersed for 1 minute using ultrasonic wave dispersion.

### Measurements

The toner particle dispersed solution in the beaker is stirred using a stirrer.

A 0.1 mol/L aqueous solution of HCl is added dropwise using a micro-pipette so as to attain a pH of 4.0.

A 0.1 mol/L aqueous solution of KOH is added dropwise as a titration solution, and the amount of silanol groups (mmol/g) is calculated on the basis of the amount of the 0.1 mol/L aqueous solution of KOH added dropwise until the pH reaches 9.0.

Method for Wettability Test with Mixed Methanol/water Solvent

In a wettability test of the toner with a mixed methanol/water solvent, measurements are carried out using the conditions and procedure described below using a powder wettability tester (“WET-100P” produced by Rhesca Co., Ltd.), and wettability is calculated from an obtained methanol dropping transmittance curve.

A fluororesin-coated spindle-like rotor having a length of 25 mm and a maximum body diameter of 8 mm is placed in a cylindrical glass container having a diameter of 5 cm and a thickness of 1.75 mm. 60 mL of water that has been treated with a reverse osmosis membrane (RO water) is placed in the cylindrical glass container, and dispersion is carried out for 5 minutes using an ultrasonic disperser in order to remove air bubbles and the like. 0.1 g of a toner is weighed out and added to the container to prepare a measurement sample liquid.

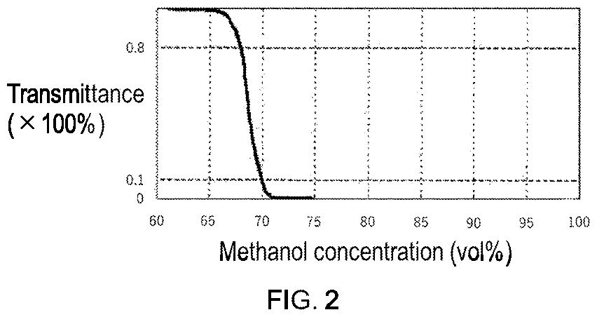

While stirring the spindle-like rotor in the cylindrical glass container at a speed of 300 rpm using a magnetic stirrer, methanol is continuously added to the measurement sample liquid at a dropping speed of 0.8 mL/min through the powder wettability tester. The transmittance of light having a wavelength of 780 nm is measured, and a methanol dropping transmittance curve such as that shown in FIG. 2 is prepared. The methanol concentration at which a transmittance of 50% is exhibited is read from the methanol dropping transmittance curve.

Methanol concentration (%) is a value calculated from (volume of methanol present in cylindrical glass container/volume of mixture of methanol and water present in cylindrical glass container)×100

Method for Measuring Content of Organosilicon Polymer

A wavelength-dispersive X-Ray fluorescence analysis apparatus (Axios produced by PANalytical) is used as the measurement apparatus, and dedicated software for this apparatus (SuperQ ver.4.0F produced by PANalytical) is used in order to measure the content of the organosilicon polymer in the toner particle.

Moreover, Rh is used as the X-Ray bulb anode, the measurement atmosphere is a vacuum, the measurement diameter (collimator mask diameter) is 27 mm, and the measurement time is 10 seconds.

In addition, detection is carried out using a proportional counter (PC) in cases where light elements are measured, and detection is carried out using a scintillation counter (SC) in cases where heavy elements are measured.

4 g of toner is placed as a measurement sample in a dedicated aluminum ring for pressing, leveled off, pressurized for 60 seconds at a pressure of 20 MPa using a “BRE-32” tablet compression molder (produced by Maekawa Testing Machine MFG. Co., Ltd.), and molded into a pellet having a thickness of 2 mm and a diameter of 39 mm.

Silicone fine particles (Tospearl 103 produced by GE Toshiba Silicones) are added at a quantity of 0.5 parts by mass relative to 100.0 parts by mass of a toner that does not contain an organosilicon polymer or external additives, and are thoroughly mixed using a coffee mill. The toner and silicone fine particles are mixed in the same way as described above, except that the amount of silicone fine particles is 5.0 parts by mass or 10.0 parts by mass, and these are used as calibration curve samples. For these samples, pellets of the calibration curve samples are produced in the manner described above using a tablet compression molder, and the count rate (units: cps) of Si-Kα rays observed at a diffraction angle (2θ) of 109.08° is measured when PET is used as a spectral crystal.

In this case, the accelerating voltage of the X-Ray generator is 24 kV, and the current is 100 mA.

A linear function calibration curve is obtained by using the obtained X-Ray count rate as the vertical axis and the added quantity of silicone fine particles in the calibration curve samples as the horizontal axis.

Next, a toner to be analyzed is formed as a pellet in the manner described above using a tablet compression molder, and the count rate of Si-Kα rays is measured. The content of the organosilicon polymer in the toner is then determined from the calibration curve.

Method for Measuring Ratio of Area of Peak Attributable to Silicon Atom Derived from Structure Represented by Formula (a) and Area of Peak Attributable to Silicon Atom Derived from Structure Represented by Formula (b) Relative to Total Peak Area Attributable to All Silicon Atoms Contained in Organosilicon Polymer Method for Preparing Sample

Measurement sample preparation: 10.0 g of toner particles is weighed out and placed in a cylindrical filter paper (No. 86R produced by Toyo Roshi Kaisha, Ltd.), attached to a Soxhlet extractor, and extracted for 20 hours using 200 mL of tetrahydrofuran as a solvent, and a product obtained by vacuum drying the filtered product in the cylindrical filter paper for several hours at 40° C. is used as an NMR measurement sample.

Solid ²⁹Si-NMR measurements of tetrahydrofuran-insoluble matter in the toner particles are carried out under the following conditions.

(Solid) ²⁹Si-NMR Measurement Conditions
Apparatus: JNM-ECX5002 produced by JEOL RESONANCE
Temperature: room temperature
Sample tube: zirconia 3.2 mm diameter
Sample: 150 mg of tetrahydrofuran-insoluble matter in toner particles for NMR measurements
Pulse mode: CP/MAS
Measurement nucleus frequency: 97.38 MHz (²⁹Si)
Standard substance: DSS (external standard: 1.534 ppm)
Sample rotation speed: 10 kHz
Contact time: 10 ms
Delay time: 2 s
Number of accumulations: 2000 to 8000

In solid ²⁹Si-NMR measurements, peaks are detected in different shift regions according to structures of functional groups bonded to Si in constituent compounds. By specifying peak positions using a standard sample, it is possible to specify structures bonded to Si. In addition, the abundance ratio of constituent compounds can be calculated from obtained peak areas. The ratio of the total peak area of M unit structures, D unit structures, T unit structures and Q unit structures relative to the total peak area can be determined through calculations.

After carrying out measurements, a plurality of silane components having different substituent groups and bonding groups are subjected to peak separation into the M unit structures, D unit structures, T unit structures and Q unit structures shown below by means of curve fitting, and the areas of these peaks are calculated.

The curve fitting is carried out using version 4.2 (EX series) of EXcalibur for Windows®, which is software for the JNM-EX400 produced by JEOL Ltd. Measurement data is read by clicking the “1D Pro” menu icon. Next, the “Curve fitting function” is selected from the “Command” in the menu bar, and curve fitting is carried out. In the curve fitting, peak splitting was carried out so that a peak of a synthetic peak difference, which is the difference between a synthetic peak and a measurement result, was the smallest.
M unit structure: (Ra)(Rb)(Rc)Si—O— (S1)
D unit structure: (Rd)(Re)Si(—O—)₂ (S2)
T unit structure: RfSi(—O—)₃ (S3)
Q unit structure: Si(—O—)₄ (S4)

S1: area of peak of M unit structure (area of peak derived from silicon atom assigned to structure represented by formula (a))

S3: area of peak of T unit structure (area of peak derived from silicon atom assigned to structure represented by formula (b))
(S1+S2+S3+S4)=SA (total area of peaks derived from all silicon atoms).

Ra, Rb, Rc, Rd, Re and Rf in formulae (S1), (S2) and (S3) denote substituent groups, such as hydrocarbon groups having 1 to 6 carbon atoms (for example, alkyl groups), and halogen atoms that are bonded to silicon atoms. Moreover, in cases where a structure needs to be confirmed in greater detail, identification may be carried out using both ²⁹Si-NMR measurement results and 13C-NMR and ¹H-NMR measurement results.

The ratio of the area of a peak derived from a silicon atom assigned to a structure represented by formula (a) relative to total peak area derived from all silicon atoms comprised in organosilicon polymer and the ratio of the area of a peak derived from a silicon atom assigned to a structure represented by formula (b) relative to total peak area derived from all silicon atoms comprised in organosilicon polymer in a chart obtained by measuring tetrahydrofuran-insoluble matter in toner particles by ²⁹Si-NMR are calculated from SA, Si and S3, which are determined in the manner described above.

Method for Measuring ST3/ST2

Sample preparation and ²⁹Si-NMR measurements are carried out in the same way as in the ²⁹Si-NMR measurements described above.

T unit structure peaks obtained by means of measurements described above are separated into peaks derived from T3 unit structures and peaks derived from T2 structures, the area of peaks derived from T3 unit structures (ST3) and the area of peaks derived from T2 unit structures (ST2) are calculated, and the value of (ST3/ST2) is calculated from these values.

Peak Separation Method

Data in a NMR spectrum obtained using the method described above is subjected to peak separation through analysis. Peak separation may be carried out by using, for example, commercially available software or a uniquely produced program, as long as the procedure described below is followed.

Peak positions are fixed on the basis that −65.0 ppm is the position of a T3 unit structure peak and −55.5 ppm is the position of a T2 unit structure peak, and peak separation processing is carried out using the Voigt function.

Method for Measuring Pa/Pb in Toner Particle

An FT-IR spectrum of the toner particle is measured using an ATR method, using Ge as an ATR crystal and at an infrared light incident angle of 45°. The arithmetic mean value of 10 samples is used.

Pa denotes the maximum absorption peak intensity, and is a value obtained by subtracting the average value of the absorption intensity at 3050 cm⁻¹ and 2600 cm⁻¹ from the maximum value of absorption peak intensity within the wavelength range 2843 to 2853 cm⁻¹. In addition, Pb denotes the maximum absorption peak intensity, and is a value obtained by subtracting the average value of the absorption intensity at 1800 cm⁻¹ and 1650 cm⁻¹ from the maximum value of absorption peak intensity within the wavelength range 1713 to 1723 cm⁻¹.

By determining Pa and Pb by means of ATR-IR and calculating the ratio of Pa relative to Pb, it is possible to express the abundance ratio of the wax relative to the binder resin at a position of approximately 0.3 μm from the surface of the toner particle.

A specific procedure for measuring Pa/Pb using an ATR method is as follows.

Measurements are carried out by means of an ATR method using a Spectrum One (Fourier transform infrared spectroscopy analyzer produced by PerkinElmer) equipped with a Universal ATR Sampling Accessory.

The infrared light incident angle is set to 45°. A Ge ATR crystal (refractive index 4.0) is used as an ATR crystal. Other conditions are as follows.
Measurement wavelength: 600 to 4000 cm⁻¹
Number of accumulations: 16
Resolution: 4.00 cm⁻¹

Method for Measuring Peak Top Temperatures of Endothermic Peaks of Crystalline Resin and Release Agent

The peak top temperatures of endothermic peaks of the crystalline resin and the release agent, as measured using differential scanning calorimetry (DSC), are measured in accordance with ASTM D3418-82 using a differential scanning calorimetry apparatus (Q2000 produced by TA Instruments).

Temperature calibration of the detector in the apparatus is performed using the melting points of indium and zinc, and heat amount calibration is performed using the heat of fusion of indium.

Specifically, 2 mg of a measurement sample is precisely weighed out and placed in an aluminum pan, an empty aluminum pan is used as a reference, and measurements are carried out under the following conditions.
Temperature increase rate: 10° C./min
Measurement start temperature: 30° C.
Measurement end temperature: 180° C.

The measurement range is 30 to 180° C., and measurements are carried out at a temperature increase rate of 10° C./min. The temperature is once increased to 180° C., held for 10 minutes, then lowered to 30° C., and then increased again. The peak top temperatures of the crystalline resin and the release agent are calculated from a temperature-endothermic amount curve within the temperature range 30 to 180° C. in this second temperature increase step.

Method for Measuring Softening Point (Tm) of Resin

The softening point of the resin is measured using a constant load extrusion type capillary rheometer “Flow Tester CFT-500D Flow Characteristics Analyzer” (produced by Shimadzu Corporation), with the measurements being carried out in accordance with the manual provided with the apparatus. In this apparatus, the temperature of a measurement sample filled in a cylinder is increased while a constant load is applied from above by means of a piston, thereby melting the sample, the molten measurement sample is extruded through a die at the bottom of the piston, and a flow curve can be obtained from the amount of piston travel and the temperature during this process.

In addition, the softening temperature was taken to be the “melting temperature by the half method” described in the manual provided with the “Flow Tester CFT-500D Flow Characteristics Analyzer”. Moreover, the melting temperature in the half method is calculated as follows.

First, half of the difference between the amount of piston travel at the completion of outflow (outflow completion point; denoted by Smax) and the amount of piston travel at the start of outflow (minimum point; denoted by Smin) is determined (this is designated as X. X=(Smax−Smin)/2). Next, the temperature in the flow curve when the amount of piston travel reaches the sum of X and Smin is taken to be the melting temperature by the half method.

The measurement sample is prepared by subjecting 1.0 g of a resin to compression molding for 60 seconds at 10 MPa in a 25° C. environment using a tablet compression molder (for example, a Standard Manual Newton Press NT-100H produced by NPa System Co., Ltd.) to provide a cylindrical shape with a diameter of 8 mm.

The specific measurement procedure is carried out in accordance with the manual provided with the apparatus.

The measurement conditions for the Flow Tester CFT-500D are as follows.
Test mode: Rising temperature method
Start temperature: 50° C.
End point temperature: 200° C.
Measurement interval: 1.0° C.
Temperature increase rate: 4.0° C./min
Piston cross section area: 1.000 cm²
Test load (piston load): 10.0 kgf/cm² (0.9807 MPa)
Preheating time: 300 sec
Diameter of die orifice: 1.0 mm
Die length: 1.0 mm

Method for Measuring Weight-average Particle Diameter (D4) of Toner Particles

The weight-average particle diameter (D4) of the toner particles is calculated by carrying out measurements using a precision particle size distribution measuring device which employees a pore electrical resistance method and uses a 100 μm aperture tube (“Coulter Counter Multisizer 3” (registered trademark) available from Beckman Coulter) and accompanying dedicated software that is used to set measurement conditions and analyze measured data (“Beckman Coulter Multisizer 3 Version 3.51 produced by Beckman Coulter) (no. of effective measurement channels: 25,000), and then analyzing the measurement data.

A solution obtained by dissolving special grade sodium chloride in ion exchanged water at a concentration of approximately 1 mass %, such as “ISOTON II” (produced by Beckman Coulter), can be used as an aqueous electrolyte solution used in the measurements. Moreover, the dedicated software was set up as follows before carrying out measurements and analysis.

On the “Standard Operating Method (SOM) alteration screen” in the dedicated software, the total count number in control mode is set to 50,000 particles, the number of measurements is set to 1, and the Kd value is set to “standard particle 10.0 μm” (Beckman Coulter). By pressing the threshold value/noise level measurement button, threshold values and noise levels are automatically set. In addition, the current is set to 1600 μA, the gain is set to 2, the electrolyte solution is set to ISOTON II, and the “Flush aperture tube after measurement” option is checked. On the “Screen for converting from pulse to particle diameter” in the dedicated software, the bin interval is set to logarithmic particle diameter, the particle diameter bin is set to 256 particle diameter bin, and the particle diameter range is set to from 2 μm to 60 μm. The specific measurement method is as follows.
(1) 200 mL of the aqueous electrolyte solution is placed in a dedicated Multisizer 3 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.
(2) 30 mL of the aqueous electrolyte solution is placed in a 100 mL glass flat bottomed beaker, and approximately 0.3 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, available from Wako Pure Chemical Industries, Ltd.) 3-fold with ion exchanged water, is added to the beaker as a dispersing agent.
(3) A prescribed amount of ion exchanged water is placed in a water bath of an “Ultrasonic Dispersion System Tetora 150” (available from Nikkaki Bios Co., Ltd.) having an electrical output of 120 W, in which 2 oscillators having an oscillation frequency of 50 kHz are housed so that their phases are staggered by 180°, and approximately 2 mL of the Contaminon N is added to the water bath.
(4) The beaker used in step (2) above is placed in a beaker-fixing hole in the ultrasonic wave disperser, and the ultrasonic wave disperser is activated. The height of the beaker is adjusted so that the resonant state of the liquid surface of the aqueous electrolyte solution in the beaker is at a maximum.
(5) While the aqueous electrolyte solution in the beaker mentioned in section (4) above is being irradiated with ultrasonic waves, approximately 10 mg of toner particles are added a little at a time to the aqueous electrolyte solution and dispersed therein. The ultrasonic wave dispersion treatment is continued for a further 60 seconds. Moreover, when carrying out the ultrasonic wave dispersion, the temperature of the water bath is adjusted as appropriate to a temperature of from 10° C. to 40° C.
(6) The aqueous electrolyte solution mentioned in section (5) above, in which the toner is dispersed, is added dropwise by means of a pipette to the round bottomed beaker mentioned in section (1) above, which is disposed on the sample stand, and the measurement concentration is adjusted to approximately 5%. Measurements are carried out until the number of particles measured reaches 50,000.
(7) The weight average particle diameter (D4) is calculated by analyzing measurement data using the accompanying dedicated software. Moreover, when setting the graph/vol. % with the dedicated software, the “average diameter” on the analysis/volume-based statistical values (arithmetic mean) screen is weight average particle diameter (D4).

### WORKING EXAMPLES

The present disclosure will now be explained in greater detail using the working examples given below. However, these working examples in no way limit the present disclosure. In the formulations below, “parts” always means parts by mass unless explicitly indicated otherwise.

Production Example of Crystalline Resin 1
Solvent: toluene: 100.0 parts
Monomer composition: 100.0 parts

The monomer composition is obtained by mixing behenyl acrylate, acrylonitrile and styrene at the proportions shown below;
Behenyl acrylate (first polymerizable monomer): 60.00 parts
Acrylonitrile (second polymerizable monomer): 16.00 parts
Styrene (third polymerizable monomer): 24.00 parts.
Polymerization initiator [t-butyl peroxypivalate (Perbutyl PV, produced NOF Corp.)]: 0.5 parts

In a nitrogen atmosphere, the materials listed above were placed in a reaction vessel equipped with a reflux condenser, a stirrer, a temperature gauge and a nitrogen inlet tube. While being stirred at 200 rpm, the contents of the reaction vessel were heated to 70° C. and a polymerization reaction was carried out for 12 hours, thereby obtaining a solution in which a polymer of the monomer composition was dissolved in toluene. The temperature of the solution was then lowered to 25° C., and the solution was introduced into 1000.0 parts of methanol under stirring, thereby causing methanol-insoluble matter to precipitate. The thus obtained methanol-insoluble matter was filtered off and washed with methanol, and then vacuum dried at 40° C. for 24 hours, thereby obtaining crystalline resin 1. The peak top temperature on a temperature-endothermic amount curve for crystalline resin 1 was 62° C.

Production Example of Amorphous Resin 1

50.0 parts of xylene was placed in an autoclave, which was then purged with nitrogen, after which the temperature of the autoclave was increased to 185° C. in a tightly sealed state under stirring. A mixed solution of 75.0 parts of styrene, 25.0 parts of n-butyl acrylate, 1.0 parts of di-tert-butyl peroxide and 20.0 parts of xylene was continuously added dropwise over a period of 3 hours and polymerized while controlling the temperature inside the autoclave to 185° C. Amorphous resin 1 was obtained by maintaining this temperature for a further 1 hour to complete polymerization and remove the solvent. The softening point (Tm) of amorphous resin 1 was 100° C.

Production Example of Polyester Resin A1
Polyoxypropylene(2.2)-2,2-bis(4-hydroxyphenyl)propane: 76.9 parts (0.167 moles)
Terephthalic acid (TPA): 25.0 parts (0.145 moles)
Adipic acid: 8.0 parts (0.054 moles)
Titanium tetrabutoxide: 0.5 parts

The materials listed above were placed in a 4 L glass four-mouthed flask, a temperature gauge, a stirrer, a condenser and a nitrogen inlet tube were attached to the flask, and flask was placed in a mantle heater. Next, the flask was purged with nitrogen gas, the temperature was gradually increased while stirring the contents of the flask, and a reaction was allowed to progress for 4 hours while stirring the contents of the flask at a temperature of 200° C. (a first reaction step). Polyester resin A1 was then obtained by adding 1.2 parts (0.006 moles) of trimellitic anhydride (TMA) and carrying out a reaction at 180° C. for 1 hour (a second reaction step).

Production Example of Polyester Resin A2
Polyoxypropylene(2.2)-2,2-bis(4-hydroxyphenyl)propane: 71.3 parts (0.155 moles)
Terephthalic acid: 24.1 parts (0.145 moles)
Titanium tetrabutoxide: 0.6 parts

The materials listed above were placed in a 4 L glass four-mouthed flask, a temperature gauge, a stirrer, a condenser and a nitrogen inlet tube were attached to the flask, and flask was placed in a mantle heater. Next, the flask was purged with nitrogen gas, the temperature was gradually increased while stirring the contents of the flask, and a reaction was allowed to progress for 2 hours while stirring the contents of the flask at a temperature of 200° C. (a first reaction step). Polyester resin A2 was then obtained by adding 5.8 parts (0.030 mol %) of trimellitic anhydride and carrying out a reaction at 180° C. for 10 hours (a second reaction step).

Production Example of Release Agent-dispersing Agent 1

300.0 parts of xylene and 10.0 parts of polypropylene (melting point 75° C.) were placed in an autoclave reaction vessel equipped with a temperature gauge and a stirrer and completely dissolved, and the reaction vessel was then purged with nitrogen. Next, a mixed solution of 73.0 parts of styrene, 5.0 parts of cyclohexyl methacrylate, 12.0 parts of butyl acrylate and 250.0 parts of xylene was added dropwise at 180° C. over a period of 3 hours and polymerization was carried out. Release agent dispersing agent 1 was then obtained by maintaining this temperature for 30 minutes and carrying out solvent removal.

Production Example of Toner Base Particles 1
Crystalline resin 1:50.0 parts
Amorphous resin 1:50.0 parts
Hydrocarbon wax (Fischer Tropsch wax; peak temperature of maximum endothermic peak: 90° C.): 20.0 parts
Release agent dispersing agent 1:5.0 parts
C.I. Pigment Blue 15:3:5.0 parts
Aluminum 3,5-di-t-butylsalicylate compound: 0.1 parts

Using a Henschel mixer (FM75 model, produced by Nippon Coke and Engineering Co., Ltd.), the raw materials shown in the formulation above were mixed at a rotational speed of 20 s⁻¹ for a period of 5 minutes, and then kneaded using a twin screw kneader (PCM-30 model, available from Ikegai Corporation) at a temperature of 125° C. and a rotational speed of 300 rpm. The obtained kneaded product was cooled and then coarsely pulverized to a diameter of not more than 1 mm using a hammer mill so as to obtain a coarsely pulverized product. The obtained coarsely pulverized product was then finely pulverized using a mechanical pulverizer (a T-250, produced by Freund Turbo Corporation).

The finely pulverized product was classified using a rotating classifier (200TSP produced by Hosokawa Micron Corp.). The rotating classifier (200TSP, available from Hosokawa Micron Corp.) was operated at a classifying rotor rotational speed of 50.0 s⁻¹.

Toner base particles 1 were then obtained by carrying out a heat treatment using a surface treatment apparatus shown in FIG. 1. Heat treatment operating conditions were a feed amount of 0.5 kg/hr, a hot air temperature of 200° C., a hot air current flow rate of 6 m³/min, a cold air temperature of −5° C., a cold air current flow rate of 2.5 m³/min, a blower flow rate of 13 m³/min and an injection air flow rate of 2 m³/min.

The obtained toner base particles 1 had a weight-average particle diameter (D4) of 5.9 μm.

Production Example of Toner Base Particles 2
Polyester resin A1:100.0 parts
Polyester resin A2:30.0 parts
Hydrocarbon wax (Fischer Tropsch wax; peak temperature of maximum endothermic peak: 90° C.): 9.0 parts
Release agent dispersing agent 1:5.0 parts
C.I. Pigment Blue 15:3:5.0 parts
Aluminum 3,5-di-t-butylsalicylate compound: 0.1 parts

Toner base particles 2 were obtained using the raw materials shown in the formulation above by carrying out production using the same method as that used in the production example of toner base particles 1, except that heat treatment operating conditions were as shown below. The obtained toner base particles 2 had a weight-average particle diameter (D4) of 5.9 μm.

Heat treatment operating conditions were a feed amount of 0.5 kg/hr, a hot air temperature of 160° C., a hot air current flow rate of 6 m³/min, a cold air temperature of −5° C., a cold air current flow rate of 2.5 m³/min, a blower flow rate of 11 m³/min and an injection air flow rate of 1 m³/min.

Production Example of Toner Base Particles 3

Toner base particles 3 were obtained by carrying out production using the same method as that used in the production example of toner base particles 2, except that release agent dispersing agent 1 was not added. The obtained toner base particles 3 had a weight-average particle diameter (D4) of 5.9 μm.

Production Example of Toner Base Particles 4

Toner base particles 4 were obtained by carrying out production using the same method as that used in the production example of toner base particles 3, except that the hydrocarbon wax was replaced by a behenyl behenate wax. The obtained toner base particles 4 had a weight-average particle diameter (D4) of 5.9 μm.

Production Examples of Toner Base Particles 5 and 6

Toner base particles 5 and 6 were obtained by carrying out production using the same method as that used in the production example of toner base particles 4, except that the type and added quantity of the release agent and the heat treatment conditions were changed as shown in Table 1. The obtained toner base particles 5 and 6 each had a weight-average particle diameter (D4) of 5.9 μm.

Production Example of Toner Base Particles 7

Toner base particles 7 were obtained by carrying out production using the same method as that used in the production example of toner base particles 4, except that the type and added quantity of the release agent were changed as shown in Table 1 and a heat treatment was not carried out. The obtained toner base particles 7 had a weight-average particle diameter (D4) of 5.9 μm.

Production Example of Toner Base Particles 8

Toner base particle 8 were obtained by carrying out production using the same method as that used in the production example of toner base particles 4, except that the type and added quantity of the release agent and the heat treatment conditions were changed as shown in Table 1. The obtained toner base particles 8 had a weight-average particle diameter (D4) of 5.9 μm.

Production Example of Toner Base Particles 9

Toner base particles 9 were obtained by carrying out production using the same method as that used in the production example of toner base particles 4, except that the type and added quantity of the release agent were changed as shown in Table 1 and a heat treatment was not carried out. The obtained toner base particles 9 had a weight-average particle diameter (D4) of 5.9 μm.

TABLE 1

| | | Number | | | |
|---|---|---|---|---|---|
| | | of parts | | Heat treatment | Hot air |
| TB | | (parts by | | step carried out? | temperature |
| No. | Release agent | mass) | Release agent dispersing agent | (Y/N) | (° C.) |
| 1 | Hydrocarbon wax | 20.0 | Release agent dispersing agent 1 | Y | 200 |
| 2 | Hydrocarbon wax | 9.0 | Release agent dispersing agent 1 | Y | 180 |
| 3 | Hydrocarbon wax | 9.0 | — | Y | 180 |
| 4 | Behenyl behenate wax | 9.0 | — | Y | 180 |
| 5 | Behenyl behenate wax | 7.0 | — | Y | 180 |
| 6 | Behenyl behenate wax | 15.0 | — | Y | 180 |
| 7 | Behenyl behenate wax | 4.0 | — | N | — |
| 8 | Behenyl behenate wax | 15.0 | — | Y | 185 |
| 9 | Behenyl behenate wax | 3.5 | — | N | — |

In the table, TB indicates toner base particles.

Production Example of Dispersion Stabilizer Aqueous Solution 1
Sodium phosphate (dodecahydrate; produced by Rasa Industries, Ltd.): 38.2 parts
Ion exchanged water: 1694.0 parts
Aqueous solution of HCl (1.0 mol/L): 47.4 parts

The materials listed above were placed in a reaction vessel equipped with a reflux condenser and a temperature gauge. Next, the reaction vessel was held at a temperature of 60° C. while being stirred at 12,000 rpm using a high-speed stirrer (a TK-Homomixer).
Ion exchanged water: 155.0 parts
Calcium chloride dihydrate: 22.1 parts

A material obtained by mixing the materials listed above (an aqueous calcium chloride solution obtained by dissolving calcium chloride dihydrate in ion exchanged water) was added gradually to the materials in the reaction vessel, thereby obtaining dispersion stabilizer aqueous solution 1, which contained an ultrafine poorly water-soluble dispersion stabilizer (Ca₃(PO₄)₂).

Production Example of Silane Compound Hydrolysis Liquid 1 (First Step for Producing Organosilicon Polymer)
Methyltriethoxysilane: 50.0 parts
Ion exchanged water: 50.0 parts

The materials listed above were placed in a reaction vessel equipped with a stirrer, the pH was adjusted to 3.0 using 10 mass % hydrochloric acid, and hydrolysis was carried out while stirring, thereby obtaining silane compound hydrolysis liquid 1. Completion of hydrolysis was confirmed when a liquid that was initially separated into two phases became one phase.

Production Example of Silane Compound Hydrolysis Liquid 2 (First Step For Producing Organosilicon Polymer)
Tetraethoxysilane: 50.0 parts
Ion exchanged water: 50.0 parts

The materials listed above were placed in a reaction vessel equipped with a stirrer, the pH was adjusted to 3.0 using 10 mass % hydrochloric acid, and hydrolysis was carried out while stirring, thereby obtaining silane compound hydrolysis liquid 1. Completion of hydrolysis was confirmed when a liquid that was initially separated into two phases became one phase.

Production Example of Toner 1 Dispersion Step in Aqueous Medium
Toner base particles 1:36.0 parts
Dispersion stabilizer aqueous solution 1:100.0 parts

The materials listed above were placed in a reaction vessel equipped with a temperature gauge. Toner base particle dispersed solution 1 was obtained by dispersing the contents of the reaction vessel for 60 minutes at a rotational speed of 12,000 rpm using a homogenizer (an Ultratarax T25 produced by IKA Japan) while maintaining the temperature inside the reaction vessel at 25° C.

Second Step for Producing Organosilicon Polymer

Toner base particle dispersed solution 1 was transferred to a reaction vessel equipped with a stirrer and a temperature gauge, and 12.7 parts of silane compound hydrolysis liquid 1 was added thereto. The temperature was adjusted to 25° C. while the contents of the reaction vessel were stirred at 400 rpm, and this state was maintained for 10 minutes. Next, the pH was adjusted to 9.5 using a 1 mol/L aqueous solution of NaOH, and a condensation reaction was carried out while stirring for 300 minutes.

Third Step for Producing Organosilicon Polymer Production example of hydrophobic treatment agent hydrolysis liquid 1
Hexamethyldisilazane (hydrophobic treatment agent): 36.0 parts
Ion exchanged water: 50.0 parts

The materials listed above were placed in a reaction vessel equipped with a stirrer, and the pH was adjusted to 4.0 using 10 mass % hydrochloric acid. Hydrophobic treatment agent hydrolysis liquid 1 was obtained by placing a lid on the reaction vessel and carrying out hydrolysis for 60 minutes while stirring.

Production Example of Hydrophobic Treatment Agent Hydrolysis Liquid 2
Tributylmethoxysilane: 50.0 parts
Ion exchanged water: 50.0 parts

The materials listed above were placed in a reaction vessel equipped with a stirrer, and the pH was adjusted to 4.0 using 10 mass % hydrochloric acid. Hydrophobic treatment agent hydrolysis liquid 2 was obtained by placing a lid on the reaction vessel and carrying out hydrolysis for 60 minutes while stirring.

Following the condensation reaction, which was after the second step for producing the organosilicon polymer, the temperature inside the reaction vessel was adjusted to 25° C. Next, 300 parts of methanol was added and the contents of the reaction vessel were stirred for 5 minutes at 400 rpm. The entire quantity of hydrophobic treatment agent hydrolysis liquid 1 was then added to the reaction vessel, a lid was placed on the reaction vessel, and the organosilicon polymer contained in the surface layer formed on the toner base particle was subjected to a hydrophobic treatment. Stirring was carried out in this state for 48 hours, thereby obtained unwashed toner particle dispersed solution 1.

Washing Step

Next, the pH was adjusted to 1.5 using dilute hydrochloric acid, and the dispersion stabilizer was removed. Toner particles and a filtrate were then separated by filtering with a Kiriyama filter paper (No. 5C; pore diameter 1 μm). The obtained toner particles were dispersed in 100 parts of methanol, and a toner particle cake was produced in a dropping funnel using a Kiriyama filter paper (No. 5C; pore diameter 1 μm). The toner particle cake was then washed with ion exchanged water until the electrical conductivity was 1.9 μS/cm. Toner particle 1 was then obtained by vacuum drying the toner particle cake at 50° C. for 48 hours.

The obtained toner particle was used as toner 1 without externally adding an external additive.

Production Examples of Toners 2 to 54

Toners 2 to 54 were obtained by carrying out production in the same way as in the production example of toner 1, except that the types and added quantities of the toner base particles and the silane compound hydrolysis liquid, the temperature and pH in the condensation reaction in the second step, and the type and added quantity of the hydrophobic treatment agent in the third step were altered as shown in Table 2 to produce unwashed toner particle dispersed solutions 2 to 48, and washing was carried out until the electrical conductivity following the washing step was a value shown in Table 3. Physical properties of toners 2 to 54 are shown in Table 3.

Production Examples of Toner 55

After obtained unwashed toner particle dispersed solution 9, a following washing step was performed.

Washing Step

The pH was adjusted to 1.5 using dilute hydrochloric acid, and the dispersion stabilizer was removed. Toner particles and a filtrate were then separated by filtering with a Kiriyama filter paper (No. 5C; pore diameter 1 um). When the obtained toner particles were washed with a sufficient amount of ion exchanged water, the electrical conductivity was 20 μS/cm, and no further change was observed. During washing, much of the toner particles were floating in water. Toner 55 was then obtained by vacuum drying at 50° C. for 48 hours. Physical properties of toner 55 are shown in Table 3.

TABLE 2

| | | | Added | | | | |
|---|---|---|---|---|---|---|---|
| | | | quantity | 2SC | | | |
| TD | TB | HL | of HL | temperature | | 3SL | AH |
| NO. | NO. | NO. | (parts) | (° C.) | 2SC pH | NO. | (parts) |
| 1 | 1 | 1 | 14.1 | 25 | 9.5 | 1 | 36 |
| 2 | 2 | 1 | 14.1 | 25 | 9.5 | 1 | 36 |
| 3 | 3 | 1 | 14.1 | 25 | 9.5 | 1 | 36 |
| 4 | 4 | 1 | 14.1 | 25 | 9.5 | 1 | 36 |
| 5 | 5 | 1 | 14.1 | 25 | 9.5 | 1 | 36 |
| 6 | 6 | 1 | 14.1 | 25 | 9.5 | 1 | 36 |
| 7 | 7 | 1 | 14.1 | 25 | 9.5 | 1 | 36 |
| 8 | 8 | 1 | 14.1 | 25 | 9.5 | 1 | 36 |
| 9 | 9 | 1 | 14.1 | 25 | 9.0 | 1 | 36 |
| 10 | 9 | 1 | 14.1 | 45 | 10 | 1 | 36 |
| 11 | 9 | 1 | 14.1 | 25 | 8.5 | 1 | 36 |
| 12 | 9 | 1 | 14.1 | 45 | 10.5 | 1 | 36 |
| 13 | 9 | 1 | 14.1 | 25 | 8.0 | 1 | 36 |
| 14 | 9 | 1 | 14.1 | 45 | 10.8 | 1 | 36 |
| 15 | 9 | 1 and 2 | 14.1/2.0 | 45 | 10.8 | 1 | 36 |
| 16 | 9 | 1 and 2 | 14.1/4.0 | 45 | 10.8 | 1 | 36 |
| 17 | 9 | 1 and 2 | 14.1/4.5 | 45 | 10.8 | 1 | 36 |
| 18 | 9 | 1 and 2 | 3.5/1.1 | 45 | 10.8 | 1 | 10 |
| 19 | 9 | 1 and 2 | 20.0/6.3 | 45 | 10.8 | 1 | 50 |
| 20 | 9 | 1 and 2 | 2.8/0.9 | 45 | 10.8 | 1 | 8 |
| 21 | 9 | 1 and 2 | 25.2/7.6 | 45 | 10.8 | 1 | 60 |
| 22 | 9 | 1 and 2 | 2.5/0.7 | 45 | 10.8 | 1 | 7 |
| 23 | 9 | 1 and 2 | 28.5/8.7 | 45 | 10.8 | 1 | 65 |
| 24 | 9 | 1 and 2 | 26.5/10.7 | 45 | 10.8 | 1 | 17 |
| 25 | 9 | 1 and 2 | 28.5/8.7 | 45 | 10.8 | 1 | 67 |
| 26 | 9 | 1 and 2 | 26.5/10.7 | 45 | 10.8 | 1 | 8 |
| 27 | 9 | 1 and 2 | 28.5/8.7 | 45 | 10.8 | 1 | 90 |
| 28 | 9 | 1 and 2 | 26.5/10.7 | 45 | 10.8 | 1 | 7 |
| 29 | 9 | 1 and 2 | 28.5/8.7 | 45 | 10.8 | 1 | 95 |
| 30 | 9 | 1 and 2 | 26.5/11.7 | 45 | 10.8 | 1 | 7 |
| 31 | 9 | 1 and 2 | 28.5/7.7 | 45 | 10.8 | 1 | 95 |
| 32 | 9 | 1 and 2 | 26.5/13.7 | 45 | 10.8 | 1 | 7 |
| 33 | 9 | 1 and 2 | 28.5/6.7 | 45 | 10.8 | 1 | 95 |
| 34 | 9 | 1 and 2 | 26.5/15.7 | 45 | 10.8 | 1 | 4 |
| 35 | 9 | 1 and 2 | 28.5/5.7 | 45 | 10.8 | 1 | 100 |
| 36 | 9 | 1 and 2 | 26.5/16.7 | 45 | 10.8 | 1 | 4 |
| 37 | 9 | 1 and 2 | 28.5/5.7 | 45 | 10.8 | 1 | 102 |
| 38 | 9 | 1 and 2 | 28.5/5.7 | 45 | 10.8 | 1 | 105 |
| 39 | 9 | 1 and 2 | 26.5/17.7 | 45 | 10.8 | 1 | 4 |
| 40 | 9 | 1 and 2 | 28.5/5.7 | 45 | 10.8 | 1 | 110 |
| 41 | 9 | 1 and 2 | 26.5/17.7 | 45 | 10.8 | 1 | 3 |
| 42 | 9 | 1 and 2 | 26.5/18.2 | 45 | 10.8 | 1 | 3 |
| 43 | 9 | 1 and 2 | 28.5/5.7 | 45 | 10.8 | 2 | 110 |
| 44 | 9 | 1 and 2 | 28.5/5.7 | 45 | 10.8 | None | — |
| 45 | 9 | 1 and 2 | 28.5/5.7 | 45 | 10.8 | 2 | 115 |
| 46 | 9 | 1 and 2 | 2.0/0.3 | 45 | 10.8 | 1 | 7 |
| 47 | 9 | 1 and 2 | 26.5/20.2 | 45 | 10.8 | 2 | 110 |
| 48 | 9 | 2 | 14.1 | 45 | 10.8 | 1 | 36 |

In the table, TD denotes an unwashed toner particle dispersed solution, TB denotes a toner base particle, HL denotes a silane compound hydrolysis liquid, 2SC denotes the condensation reaction in the second step, 3SL denotes a hydrophobic treatment agent hydrolysis liquid in the third step, and AH denotes the added quantity of hydrophobic treatment agent.

TABLE 3

| | | Electrical | | | Amount of | Methanol | | Content of | | | |
|---|---|---|---|---|---|---|---|---|---|---|---|
| Toner | | conductivity | Ratio | Ratio | silanol groups | concentration | Ratio of | OS | Ratio of | | |
| No. | TD No. | (μS/cm) | of C | of Si | (mmol/g) | (%) | (a) | (mass %) | (b) | T3/T2 | Pa/Pb |
| 1 | 1 | 1.9 | 52 | 16 | 0.050 | 58 | 0.040 | 10.0 | 0.96 | 3.5 | 0.23 |
| 2 | 2 | 1.9 | 52 | 16 | 0.050 | 58 | 0.040 | 10.0 | 0.96 | 3.5 | 0.30 |
| 3 | 3 | 1.9 | 52 | 16 | 0.050 | 58 | 0.040 | 10.0 | 0.96 | 3.5 | 0.28 |
| 4 | 4 | 1.9 | 52 | 16 | 0.050 | 58 | 0.040 | 10.0 | 0.96 | 3.5 | 0.25 |
| 5 | 5 | 1.9 | 52 | 16 | 0.050 | 58 | 0.040 | 10.0 | 0.96 | 3.5 | 0.22 |
| 6 | 6 | 1.9 | 52 | 16 | 0.050 | 58 | 0.040 | 10.0 | 0.96 | 3.5 | 0.40 |
| 7 | 7 | 1.9 | 52 | 16 | 0.050 | 58 | 0.040 | 10.0 | 0.96 | 3.5 | 0.15 |
| 8 | 8 | 1.9 | 52 | 16 | 0.050 | 58 | 0.040 | 10.0 | 0.96 | 3.5 | 0.41 |
| 9 | 9 | 1.9 | 52 | 16 | 0.050 | 58 | 0.040 | 10.0 | 0.96 | 3.2 | 0.14 |
| 10 | 10 | 1.9 | 52 | 16 | 0.050 | 58 | 0.040 | 10.0 | 0.96 | 4.0 | 0.14 |
| 11 | 11 | 1.9 | 52 | 16 | 0.050 | 58 | 0.040 | 10.0 | 0.96 | 3.0 | 0.14 |
| 12 | 12 | 1.9 | 52 | 16 | 0.050 | 58 | 0.040 | 10.0 | 0.96 | 4.5 | 0.14 |
| 13 | 13 | 1.9 | 52 | 16 | 0.050 | 58 | 0.040 | 10.0 | 0.96 | 2.9 | 0.14 |
| 14 | 14 | 1.9 | 52 | 16 | 0.050 | 58 | 0.040 | 10.0 | 0.96 | 4.6 | 0.14 |
| 15 | 15 | 1.9 | 52 | 17 | 0.053 | 57 | 0.040 | 11.0 | 0.92 | 4.6 | 0.14 |
| 16 | 16 | 1.9 | 52 | 18 | 0.055 | 56 | 0.040 | 12.0 | 0.90 | 4.6 | 0.14 |
| 17 | 17 | 1.9 | 52 | 18 | 0.056 | 55 | 0.040 | 12.0 | 0.89 | 4.6 | 0.14 |
| 18 | 18 | 1.9 | 54 | 12 | 0.056 | 55 | 0.040 | 5.0 | 0.89 | 4.6 | 0.14 |
| 19 | 19 | 1.9 | 50 | 20 | 0.056 | 55 | 0.040 | 20.0 | 0.89 | 4.6 | 0.14 |
| 20 | 20 | 1.9 | 55 | 11 | 0.056 | 55 | 0.040 | 4.0 | 0.89 | 4.6 | 0.14 |
| 21 | 21 | 1.9 | 50 | 25 | 0.056 | 55 | 0.040 | 30.0 | 0.89 | 4.6 | 0.14 |
| 22 | 22 | 1.9 | 56 | 10 | 0.056 | 55 | 0.040 | 3.0 | 0.89 | 4.6 | 0.14 |
| 23 | 23 | 1.9 | 50 | 26 | 0.056 | 55 | 0.040 | 31.0 | 0.89 | 4.6 | 0.14 |
| 24 | 24 | 1.9 | 47 | 26 | 0.060 | 50 | 0.010 | 31.0 | 0.88 | 4.6 | 0.14 |
| 25 | 25 | 1.9 | 52 | 25 | 0.030 | 58 | 0.050 | 31.0 | 0.88 | 4.6 | 0.14 |
| 26 | 26 | 1.9 | 42 | 26 | 0.065 | 47 | 0.005 | 31.0 | 0.89 | 4.6 | 0.14 |
| 27 | 27 | 1.9 | 55 | 22 | 0.020 | 63 | 0.080 | 31.0 | 0.85 | 4.6 | 0.14 |
| 28 | 28 | 1.9 | 42 | 26 | 0.068 | 46 | 0.004 | 31.0 | 0.89 | 4.6 | 0.14 |
| 29 | 29 | 1.9 | 55 | 22 | 0.015 | 64 | 0.085 | 31.0 | 0.85 | 4.6 | 0.14 |
| 30 | 30 | 1.9 | 42 | 26 | 0.068 | 45 | 0.004 | 31.0 | 0.88 | 4.6 | 0.14 |
| 31 | 31 | 1.9 | 55 | 22 | 0.015 | 65 | 0.085 | 31.0 | 0.86 | 4.6 | 0.14 |
| 32 | 32 | 1.9 | 42 | 26 | 0.068 | 40 | 0.004 | 31.0 | 0.89 | 4.6 | 0.14 |
| 33 | 33 | 1.9 | 55 | 22 | 0.012 | 68 | 0.090 | 31.0 | 0.85 | 4.6 | 0.14 |
| 34 | 34 | 1.9 | 42 | 26 | 0.070 | 35 | 0.003 | 31.0 | 0.89 | 4.6 | 0.14 |
| 35 | 35 | 1.9 | 56 | 23 | 0.011 | 70 | 0.095 | 31.0 | 0.86 | 4.6 | 0.14 |
| 36 | 36 | 1.9 | 42 | 26 | 0.071 | 34 | 0.002 | 31.0 | 0.89 | 4.6 | 0.14 |
| 37 | 37 | 1.9 | 56 | 26 | 0.011 | 71 | 0.100 | 31.0 | 0.85 | 4.6 | 0.14 |
| 38 | 38 | 1.9 | 57 | 25 | 0.010 | 71 | 0.110 | 31.0 | 0.84 | 4.6 | 0.14 |
| 39 | 39 | 1.9 | 41 | 26 | 0.075 | 34 | 0.002 | 31.0 | 0.89 | 4.6 | 0.14 |
| 40 | 40 | 1.9 | 58 | 24 | 0.005 | 75 | 0.150 | 31.0 | 0.80 | 4.6 | 0.14 |
| 41 | 41 | 1.9 | 41 | 26 | 0.080 | 34 | 0.001 | 31.0 | 0.89 | 4.6 | 0.14 |
| 42 | 42 | 1.9 | 40 | 26 | 0.080 | 34 | 0.001 | 31.0 | 0.89 | 4.6 | 0.14 |
| 43 | 43 | 1.9 | 60 | 26 | 0.004 | 75 | 0.150 | 31.0 | 0.80 | 4.6 | 0.14 |
| 44 | 43 | 1.5 | 60 | 26 | 0.004 | 75 | 0.150 | 31.0 | 0.80 | 4.6 | 0.14 |
| 45 | 43 | 2.3 | 60 | 26 | 0.004 | 75 | 0.150 | 31.0 | 0.80 | 4.6 | 0.14 |
| 46 | 43 | 1.0 | 60 | 26 | 0.004 | 75 | 0.150 | 31.0 | 0.80 | 4.6 | 0.14 |
| 47 | 43 | 2.5 | 60 | 26 | 0.004 | 75 | 0.150 | 31.0 | 0.80 | 4.6 | 0.14 |
| 48 | 40 | 2.6 | 58 | 24 | 0.005 | 75 | 0.150 | 31.0 | 0.80 | 4.6 | 0.14 |
| 49 | 40 | 0.9 | 58 | 24 | 0.005 | 75 | 0.150 | 31.0 | 0.80 | 4.6 | 0.14 |
| 50 | 44 | 1.9 | 35 | 18 | 0.100 | 25 | Not treated | 31.0 | 0.89 | 4.6 | 0.14 |
| 51 | 45 | 1.9 | 62 | 25 | 0.080 | 75 | 0.150 | 31.0 | 0.80 | 4.6 | 0.14 |
| 52 | 46 | 1.9 | 56 | 9 | 0.056 | 55 | 0.040 | 2.5 | 0.89 | 4.6 | 0.14 |
| 53 | 47 | 1.9 | 40 | 28 | 0.080 | 50 | 0.040 | 31.0 | 0.80 | 4.6 | 0.14 |
| 54 | 48 | 1.9 | 9 | 27 | 0.100 | 34 | 0.040 | 10.0 | 0.00 | 0.0 | 0.14 |
| 55 | 9 | 20 | 52 | 16 | 0.050 | 58 | 0.040 | 10.0 | 0.96 | 3.2 | 0.14 |

In the table, TD denotes an unwashed toner particle dispersed solution, Ratio of C denotes the ratio of the carbon concentration relative to the sum total of the carbon concentration, oxygen concentration and silicon concentration measured using ESCA (dC/(dC+dO+dSi)×100), Ratio of Si denotes the ratio of the silicon concentration relative to the sum total of the carbon concentration, oxygen concentration and silicon concentration measured using ESCA (dSi/(dC+dO+dSi)×100), Ratio of (a) denotes the ratio of the area of a peak derived from a silicon atom assigned to a structure represented by formula (a) relative to the total area of peaks derived from all silicon atoms comprised in the organosilicon polymer, OS denotes an organosilicon polymer, and Ratio of (b) denotes the ratio of the area of a peak derived from a silicon atom assigned to a structure represented by formula (b) relative to the total area of peaks derived from all silicon atoms comprised in the organosilicon polymer.

Production Example of Magnetic Carrier Core Particle 1
Step 1 (Weighing out/mixing step):
Fe₂O₃: 62.7 parts
MnCO₃: 29.5 parts
Mg(OH)₂: 6.8 parts
SrCO₃: 1.0 parts

The ferrite raw materials were weighed out so that the materials listed above had the compositional ratio mentioned above. Next, the materials were pulverized and mixed for 5 hours in a dry vibrating mill using stainless steel beads having diameters of ⅛ inch.

Step 2 (Calcining step):

The obtained pulverized product was formed into pellets measuring approximately 1 mm square using a roller compactor. Coarse particles were removed from these pellets using a vibrating sieve having an opening size of 3 mm, after which fine particles were removed using a vibrating sieve having an opening size of 0.5 mm, and a calcined ferrite was then prepared by firing for 4 hours at 1000° C. in a nitrogen atmosphere (oxygen concentration: 0.01 vol. %) using a burner type kiln. The composition of the obtained calcined ferrite was as follows.

(MnO)ₐ(MgO)_{b}(SrO)_{c}(Fe₂O₃)_{d}

In the compositional formula above, a=0.257, b=0.117, c=0.007 and d=0.393.

Step 3 (Pulverization step):

The calcined ferrite was pulverized to a size of approximately 0.3 mm using a crusher, water was added at a quantity of 30 parts relative to 100 parts of the calcined ferrite, and the calcined ferrite was then pulverized for 1 hour in a wet ball mill using zirconia beads having diameters of ⅛ inch. This slurry was pulverized for 4 hours in a wet ball mill using alumina beads having diameters of 1/16 inch to obtain a ferrite slurry (a finely pulverized calcined ferrite).

Step 4 (Granulating step):

1.0 parts of ammonium polycarboxylate as a dispersing agent and 2.0 parts of poly(vinyl alcohol) as a binder, each relative to 100 parts of the calcined ferrite, were added to the ferrite slurry, and the slurry was then granulated into spherical particles using a spray dryer (manufactured by Ohkawara Kakohki Co., Ltd.). After adjusting the diameters of the obtained particles, the particles were heated for 2 hours at 650° C. using a rotary kiln, and organic components, such as the dispersing agent and binder, were removed.

Step 5 (Firing step):

In order to control the firing atmosphere, the temperature was increased from room temperature to 1300° C. over a period of 2 hours in a nitrogen atmosphere (oxygen concentration: 1.00 vol. %) using an electric furnace, after which firing was carried out for 4 hours at a temperature of 1150° C. The temperature was then lowered to 60° C. over a period of 4 hours, the nitrogen atmosphere was allowed to return to an air atmosphere, and the fired product was taken out at a temperature of 40° C. or lower.

Step 6 (Sorting step):

After crushing the aggregated particles, particles having a low magnetic force were removed by means of magnetic separation, and coarse particles were removed by sieving with a sieve having an opening size of 150 μm. The obtained particles were porous and had pores.

Step 7 (Filling step) 100 parts by mass of the obtained porous magnetic core particles were placed in a stirring container of a mixing and stirring device (product name: NDMV All-Purpose Stirrer, produced by Dalton), and nitrogen was introduced while maintaining a temperature of 60° C. and reducing the pressure to 2.3 kPa.

In addition, a mixture was prepared by stirring and mixing 50 parts by mass of a silicone resin (product name: SR2410, produced by Dow Corning Toray Silicone Co., Ltd.) with 49.5 parts by mass of toluene and 0.5 parts by mass of y-aminopropyltriethoxysilane for 10 minutes using a multi-blender mixer.

The obtained mixture was added dropwise to the porous magnetic core particles in the mixing and stirring device. The quantity added dropwise was adjusted so as to be 4.0 parts by mass in terms of solid resin content relative to 100 parts by mass of the porous magnetic core particles.

Following completion of the dropwise addition, stirring was continued in the same way for 2.5 hours, after which the temperature was increased to 70° C., and the solvent was removed under reduced pressure, thereby causing the resin composition to be filled in the porous magnetic core particles.

After being cooled, the obtained resin-filled magnetic core particles were transferred to a container of a stirrer (mixer) having a spiral vane (product name: UD-AT type drum mixer, produced by Sugiyama Heavy Industrial Co., Ltd.). Next, the temperature was increased to 220° C., which was the preset temperature of the stirrer, at a temperature increase rate of 2° C./min in a nitrogen atmosphere. The resin-filled magnetic core particles were stirred for 1.0 hours while being heated at this temperature, the resin was cured, and stirring was then continued for a further 1.0 hours while maintaining a temperature of 200° C.

Next, the resin-filled magnetic core particles were cooled to room temperature (25° C.), ferrite particles filled with the cured resin were taken out, and non-magnetic substances were removed using a magnetic separator. Coarse particles were then removed using a vibrating sieve, thereby obtaining resin-filled magnetic carrier core 1. The 50% particle diameter on a volume distribution basis (D50) of magnetic carrier core 1 was 38.5 μm.

### Preparation of Coating Resin 1

Cyclohexyl methacrylate monomer: 26.8 mass %
Methyl methacrylate monomer: 0.2 mass %
Methyl methacrylate macromonomer: 8.4 mass %
(Macromonomer having a weight average molecular weight of 5000 and having a methacryloyl group at one terminal)
Toluene: 31.3 mass %
Methyl ethyl ketone: 31.3 mass %
Azobisisobutyronitrile: 2.0 mass %

Of the materials listed above, the cyclohexyl methacrylate, methyl methacrylate monomer, methyl methacrylate macromonomer, toluene and methyl ethyl ketone were added to a four-mouth separable flask equipped with a reflux condenser, a temperature gauge, a nitrogen inlet tube and a stirrer, nitrogen gas was introduced so as to obtain a suitable nitrogen atmosphere, the temperature was increased to 80° C., azobisisobutyronitrile was added, and polymerization was carried out for 5 hours while refluxing. Hexane was added to the obtained reaction product so as to precipitate a copolymer, and the precipitate was filtered and then vacuum dried so as to obtain coating resin 1. 30 parts of the obtained coating resin 1 was dissolved in 40 parts of toluene and 30 parts of methyl ethyl ketone so as to obtain polymer solution 1 (solid content: 30 mass %).

### Preparation of Coating Resin Solution 1

Polymer solution 1 (solid resin content concentration 30%): 33.3 mass %
Toluene: 66.4 mass %
Carbon black (Regal 330 produced by Cabot): 0.3 mass %
(Primary particle diameter: 25 nm, nitrogen adsorption specific surface area: 94 m²/g,
DBP absorption number: 75 mL/100 g)

The materials listed above were dispersed for 1 hour in a paint shaker using zirconia beads having diameters of 0.5 mm. The obtained dispersed solution was filtered using a 5.0 μm membrane filter to obtain coating resin solution 1.

Production Example of Magnetic Carrier 1

### Resin Coating Step

Coating resin solution 1 was introduced into a vacuum deaeration type kneader maintained at normal temperature so that the amount of resin component was 2.5 parts relative to 100 parts of resin-filled magnetic carrier core particles 1. Following the introduction, stirring was carried out for 15 minutes at a rotational speed of 30 rpm, and after at least a certain amount (80 mass %) of the solvent had evaporated, the temperature was increased to 80° C. while mixing under reduced pressure, toluene was distilled off over a period of 2 hours, and cooling was then carried out.

Magnetic Carrier 1 having a 50% particle diameter on a volume basis (D50) of 38.2 μm was then obtained by separating particles having a low magnetic force from the obtained magnetic carrier by means of magnetic separation, passing the magnetic carrier through a sieve having an opening size of 70 μm, and then classifying using an air classifier.

Production Example of Magnetic Body Particle A-1

Fe₂O₃ was mixed and pulverized for 10 hours in a wet ball mill. 1 part by mass of poly(vinyl alcohol) was added, and the obtained mixture was granulated and dried using a spray dryer. The dried product was fired for 10 hours at 900° C. in a nitrogen atmosphere having an oxygen concentration of 0.0 vol % using an electric furnace.

The obtained magnetic body was pulverized for 5 hours using a dry ball mill, and then classified using a wind force classifier (Elbow-Jet Labo EJ-L3 produced by Nittetsu Mining Co., Ltd.) so as to simultaneously classify and remove fine powder and coarse powder, thereby obtaining magnetic body particles A-1.

The obtained magnetic body particles A-1 and a silane-based coupling agent (3-glycidoxypropylmethyldimethoxysilane) (at a quantity of 0.2 parts by mass relative to 100 parts by mass of magnetite fine particles) were introduced into a container. Next, the contents of the container were mixed and stirred at high speed for 1 hour at 100° C. so as to subject the magnetic body particles A-1 to a surface treatment and obtain surface-treated magnetic body particles A-1.

Production Example of Magnetic Body Particle B-1

While flushing a reaction vessel having a gas inlet tube with nitrogen gas at a rate of 18 L/min, 26.7 L of an aqueous solution of ferrous sulfate containing 1.5 mol/L of Fe²⁺ and 1.0 L of an aqueous solution of No. 3 sodium silicate containing 0.2 mol/L of Si⁴⁺ were added to 22.3 L of an aqueous sodium hydroxide solution with a concentration of 3.4 mol/L, and the temperature was increased to 90° C. at a pH of 6.8. 1.2 L of an aqueous sodium hydroxide solution with a concentration of 3.5 mol/L was then added to adjust the pH to 7.9, stirring was continued, the flushed nitrogen gas was replaced by air, and aeration was carried out for 90 minutes at a rate of 100 L/min. Next, the pH was neutralized to 7 using dilute sulfuric acid, and the generated particles were washed with water, filtered, dried and classified, thereby obtaining magnetic body particles B-1.

The obtained magnetic body particles B-1 and a silane-based coupling agent (3-glycidoxypropylmethyldimethoxysilane) (at a quantity of 1.4 parts by mass relative to 100 parts by mass of magnetite fine particles) were introduced into a container. Next, the contents of the container were mixed and stirred at high speed for 1 hour at 100° C. so as to subject the magnetic body particles B-1 to a surface treatment and obtain surface-treated magnetic body particles B-1.

Production Example of Magnetic Core Particle 2
Phenol: 10.0 parts by mass
Formaldehyde solution (37 mass % aqueous solution of formaldehyde): 15.0 parts by mass
Surface-treated magnetic body particles A-1: 70.0 parts by mass
Surface-treated magnetic body particles B-1: 30.0 parts by mass
25 mass % aqueous ammonia: 3.5 parts by mass
Water: 15.0 parts by mass

The materials listed above were placed in a reaction pot and thoroughly mixed at a temperature of 40° C. Next, the temperature was increased at an average temperature increase rate of 1.5° C./min while stirring, the reaction pot was heated to 85° C., and curing was effected by carrying out a polymerization reaction for 3 hours while maintaining a temperature of 85° C. The peripheral speed of the stirring blade at this point was 1.96 msec.

Following completion of the polymerization reaction, the product was cooled to a temperature of 30° C., and water was added. A precipitate obtained by removing the supernatant liquid was washed with water and then air-dried. The obtained air-dried product was dried at a temperature of 60° C. under reduced pressure (5 hPa or less), thereby obtaining magnetic core particles 2, in which magnetic body particles are dispersed.

Production Example of Magnetic Carrier 2

Magnetic core particles 2 were placed in a planetary mixer maintained at a reduced pressure (1.5 kPa) and a temperature of 60° C. (a Nauta mixer VN produced by Hosokawa Micron Corp.), and coating resin solution 1 was introduced into the mixer so that the amount of solid resin content was 1.2 parts by mass relative to 100 parts by mass of the magnetic core particles 2. The method of introduction involved introducing a third of the quantity of the coating resin solution 1, removing solvent for 20 minutes, and carrying out a coating procedure. Next, a further third of the quantity of the coating resin solution 1 was introduced, solvent was removed for 20 minutes and a coating procedure was carried out, and then a further third of the quantity of the coating resin solution 1 was introduced, solvent was removed for 20 minutes and a coating procedure was carried out.

Next, the coating resin composition-coated magnetic carrier was transferred to a mixer having a spiral vane in a rotatable mixing container (a UD-AT type drum mixer produced by Sugiyama Heavy Industrial Co., Ltd.). While stirring and rotating the mixing container 10 times per minute, the contents of the container were heat-treated for 2 hours at 120° C. in a nitrogen atmosphere.

Particles having a low magnetic force were separated from the obtained magnetic carrier by means of magnetic separation, and the magnetic carrier was passed through a sieve having an opening size of 150 μm, and then classified using an air classifier. Obtained thereby was magnetic carrier 2, which had a 50% particle diameter on a volume basis (D50) of 35.0 μm.

Production Example of Two Component Developer 1

Two component developer 1 was obtained by adding 8.0 parts by mass of toner 1 to 92.0 parts by mass of magnetic carrier 1, and mixing using a V type mixer (a V-20 produced by Seishin Enterprise Co., Ltd.).

Production Examples of Two Component Developers 2 to 56

Two component developers 2 to 56 were obtained by carrying out production in the same way as in the production example of two component developer 1, except that the toner and the magnetic carrier were changed in the manner shown in Table 4.

TABLE 4

| Two component developer No. | Toner No. | Carrier No. |
|---|---|---|
| 1 | 1 | 1 |
| 2 | 1 | 2 |
| 3 | 2 | 2 |
| 4 | 3 | 2 |
| 5 | 4 | 2 |
| 6 | 5 | 2 |
| 7 | 6 | 2 |
| 8 | 7 | 2 |
| 9 | 8 | 2 |
| 10 | 9 | 2 |
| 11 | 10 | 2 |
| 12 | 11 | 2 |
| 13 | 12 | 2 |
| 14 | 13 | 2 |
| 15 | 14 | 2 |
| 16 | 15 | 2 |
| 17 | 16 | 2 |
| 18 | 17 | 2 |
| 19 | 18 | 2 |
| 20 | 19 | 2 |
| 21 | 20 | 2 |
| 22 | 21 | 2 |
| 23 | 22 | 2 |
| 24 | 23 | 2 |
| 25 | 24 | 2 |
| 26 | 25 | 2 |
| 27 | 26 | 2 |
| 28 | 27 | 2 |
| 29 | 28 | 2 |
| 30 | 29 | 2 |
| 31 | 30 | 2 |
| 32 | 31 | 2 |
| 33 | 32 | 2 |
| 34 | 33 | 2 |
| 35 | 34 | 2 |
| 36 | 35 | 2 |
| 37 | 36 | 2 |
| 38 | 37 | 2 |
| 39 | 38 | 2 |
| 40 | 39 | 2 |
| 41 | 40 | 2 |
| 42 | 41 | 2 |
| 43 | 42 | 2 |
| 44 | 43 | 2 |
| 45 | 44 | 2 |
| 46 | 45 | 2 |
| 47 | 46 | 2 |
| 48 | 47 | 2 |
| 49 | 48 | 2 |
| 50 | 49 | 2 |
| 51 | 50 | 2 |
| 52 | 51 | 2 |
| 53 | 52 | 2 |
| 54 | 53 | 2 |
| 55 | 54 | 2 |
| 56 | 55 | 2 |

Methods for Evaluating Two Component Developer

### Image Density Measurements

Using an imagePress C800 full color copier produced by Canon as an image forming apparatus, the two component developer was placed in the cyan developing device of the image forming apparatus, and the toner was placed in the cyan toner container, and the following evaluations were carried out. A modification was made so that the mechanism for discharging excess magnetic carrier in the developing device from the developing device was removed. GF-0081 ordinary paper (A4, basis weight 81.4 g/m², sold by Canon Marketing Japan) was used as the evaluation paper.

Adjustments were made so that the toner laid-on level on a paper for an FFh image (a solid image) was 0.45 mg/cm². FFh is a value that indicates 256 colors as 16 binary numbers, with 00h denoting the 1st gradation of 256 colors (a white background part), and FF denoting the 256th gradation of 256 colors (a solid part). Firstly, an image output test was conducted by printing 10,000 prints at an image ratio of 1%. While continuously feeding 10,000 sheets of paper, paper feeding was carried out under the same developing conditions and transfer conditions (no calibration) as those used when printing the first print.

Next, an image output test was conducted by printing 10,000 prints at an image ratio of 80%. While continuously feeding 10,000 sheets of paper, paper feeding was carried out under the same developing conditions and transfer conditions (no calibration) as those used when printing the first print. The image density of the 1st print printed at an image ratio of 1% was taken to be the initial density, and the density of the 10,000th image printed at an image ratio of 80% was measured and evaluated.

These tests were carried out in a normal temperature normal humidity environment (N/N; temperature 25° C., relative humidity 55%) and a low temperature low humidity environment (L/L; temperature 15° C., relative humidity 10%). Using an X-Rite color reflection densitometer (500 Series produced by X-Rite), the initial density and the density of the 10,000th print printed at an image ratio of 80% were measured, and this difference Δ was ranked according to the following criteria. An evaluation of D or better was assessed as being good.
(Evaluation criteria: image density difference Δ)
A: Less than 0.02
B: 0.02 or more and less than 0.05
C: 0.05 or more and less than 0.10
D: 0.10 or more and less than 0.15
E: 0.15 or more

Evaluation of Image Density Uniformity

After outputting the 10,000th image at an image ratio of 80%, solid images were outputted, images measuring 2 cm on each side were captured using a digital microscope, the captured images were converted into 8 bit gray scale using Image-J, density histograms were measured, and the standard deviation thereof was determined. These standard deviation values were ranked according to the following evaluation criteria. These tests were carried out in a normal temperature normal humidity environment (N/N; temperature 25° C., relative humidity 55%) and a low temperature low humidity environment (L/L; temperature 15° C., relative humidity 10%). An evaluation of D or better was assessed as being good.
A: Standard deviation: less than 2.0
B: Standard deviation: 2.0 or more and less than 4.0
C: Standard deviation: 4.0 or more and less than 5.0
D: Standard deviation: 5.0 or more and less than 6.0
E: Standard deviation: 6.0 or more

Image Quality

After outputting the 10,000th image at an image ratio of 80% and outputting solid images, vertical line images comprising 1 dot and 1 space were outputted. Blur (a numerical value that indicates the degree of blurring of a line, as defined in ISO 13660) was used as an indicator of image properties. Measurements were carried out using a personal IAS (image analysis system) (produced by QEA). These tests were carried out in a normal temperature normal humidity environment (N/N; temperature 25° C., relative humidity 55%) and a low temperature low humidity environment (L/L; temperature 15° C., relative humidity 10%). The obtained blur value was evaluated using the evaluation criteria shown below. An evaluation of D or better was assessed as being good.
A: Blur value less than 35 μm
B: Blur value 35 μm or more and less than 38 μm
C: Blur value 38 μm or more and less than 41 μm
D: Blur value 41 μm or more and less than 44 μm
E: Blur value 44 μm or more

Evaluation of Charge Retention Rate (in High Temperature High Humidity Environment)

0.01 g of toner was weighed out into an aluminum pan and charged to −600 V using a corona charging apparatus (product name: KTB-20, produced by Kasuga Denki, Inc.). Next, changes in surface potential behavior were measured for 30 minutes in a H/H environment using a surface potentiometer (model 347 produced by Trek Japan).

Charge retention rate was calculated from the formula below using the measurement results. Static charge retention rate was evaluated on the basis of this charge retention rate. The evaluation results are shown in Table 5.

Charge retention rate (%) after 30 minutes=(surface potential after 30 minutes/initial surface potential)×100

An evaluation of D or better was assessed as being good.

### Evaluation Criteria

AA: Charge retention rate of 95% or more
A: Charge retention rate of 90% or more and less than 95%
BB: Charge retention rate of 85% or more and less than 90%
B: Charge retention rate of 80% or more and less than 85%
CC: Charge retention rate of 75% or more and less than 80%
C: Charge retention rate of 70% or more and less than 75%
D: Charge retention rate of 50% or more and less than 70%
E: Charge retention rate of less than 50%

### Evaluation Results

Evaluation results for Working Examples 1 to 48 and Comparative Examples 1 to 8 are shown in Table 5.

TABLE 5

| | Two | | | | | Image density | | | | | | | | Charge retention | |
|---|---|---|---|---|---|---|---|---|---|---|---|---|---|---|---|
| | component | Image density | | | | uniformity | | | | Image quality | | | | characteristics | |
| | developer | NN | | LL | | NN | | LL | | NN | | LL | | HH | |
| NO. | No. | Δ | R | Δ | R | SD | R | SD | R | Blur value | R | Blur value | R | Retention rate | R |
| Example 1 | 1 | 0.01 | A | 0.01 | A | 1.5 | A | 1.5 | A | 25 | A | 26 | A | 96 | AA |
| Example 2 | 2 | 0.01 | A | 0.02 | B | 1.6 | A | 2.0 | B | 26 | A | 29 | A | 96 | AA |
| Example 3 | 3 | 0.01 | A | 0.02 | B | 1.6 | A | 2.0 | B | 27 | A | 34 | A | 96 | AA |
| Example 4 | 4 | 0.01 | A | 0.02 | B | 1.7 | A | 2.3 | B | 29 | A | 35 | B | 96 | AA |
| Example 5 | 5 | 0.02 | B | 0.02 | B | 1.7 | A | 2.5 | B | 30 | A | 35 | B | 96 | AA |
| Example 6 | 6 | 0.02 | B | 0.02 | B | 1.8 | A | 2.7 | B | 31 | A | 35 | B | 96 | AA |
| Example 7 | 7 | 0.02 | B | 0.03 | B | 1.9 | A | 2.9 | B | 32 | A | 35 | B | 96 | AA |
| Example 8 | 8 | 0.02 | B | 0.03 | B | 2.0 | B | 3.0 | B | 33 | A | 36 | B | 96 | AA |
| Example 9 | 9 | 0.02 | B | 0.03 | B | 2.0 | B | 3.2 | B | 35 | B | 36 | B | 96 | AA |
| Example 10 | 10 | 0.02 | B | 0.04 | B | 2.0 | B | 3.3 | B | 35 | B | 36 | B | 96 | AA |
| Example 11 | 11 | 0.03 | B | 0.04 | B | 2.1 | B | 3.4 | B | 36 | B | 36 | B | 96 | AA |
| Example 12 | 12 | 0.03 | B | 0.05 | C | 2.1 | B | 3.6 | B | 36 | B | 36 | B | 96 | AA |
| Example 13 | 13 | 0.03 | B | 0.05 | C | 2.3 | B | 4.0 | C | 36 | B | 36 | B | 96 | AA |
| Example 14 | 14 | 0.04 | B | 0.05 | C | 2.5 | B | 4.0 | C | 36 | B | 37 | B | 96 | AA |
| Example 15 | 15 | 0.04 | B | 0.05 | C | 2.6 | B | 4.1 | C | 37 | B | 37 | B | 96 | AA |
| Example 16 | 16 | 0.04 | B | 0.06 | C | 2.8 | B | 4.1 | C | 37 | B | 37 | B | 96 | AA |
| Example 17 | 17 | 0.04 | B | 0.06 | C | 3.0 | B | 4.1 | C | 37 | B | 38 | C | 96 | AA |
| Example 18 | 18 | 0.05 | C | 0.06 | C | 3.2 | B | 4.2 | C | 37 | B | 38 | C | 96 | AA |
| Example 19 | 19 | 0.05 | C | 0.06 | C | 3.5 | B | 4.2 | C | 37 | B | 38 | C | 96 | AA |
| Example 20 | 20 | 0.05 | C | 0.07 | C | 3.9 | B | 4.2 | C | 37 | B | 38 | C | 95 | AA |
| Example 21 | 21 | 0.06 | C | 0.07 | C | 4.0 | C | 4.3 | C | 37 | B | 38 | C | 95 | AA |
| Example 22 | 22 | 0.06 | C | 0.07 | C | 4.1 | C | 4.3 | C | 37 | B | 38 | C | 95 | AA |
| Example 23 | 23 | 0.06 | C | 0.07 | C | 4.1 | C | 4.4 | C | 38 | C | 38 | C | 95 | AA |
| Example 24 | 24 | 0.06 | C | 0.07 | C | 4.2 | C | 4.5 | C | 38 | C | 38 | C | 95 | AA |
| Example 25 | 25 | 0.07 | C | 0.08 | C | 4.3 | C | 4.6 | C | 38 | C | 38 | C | 95 | AA |
| Example 26 | 26 | 0.07 | C | 0.09 | C | 4.4 | C | 4.7 | C | 38 | C | 38 | C | 95 | AA |
| Example 27 | 27 | 0.07 | C | 0.10 | D | 4.4 | C | 4.8 | C | 39 | C | 38 | C | 95 | AA |
| Example 28 | 28 | 0.07 | C | 0.10 | D | 4.4 | C | 4.9 | D | 39 | C | 39 | C | 95 | AA |
| Example 29 | 29 | 0.08 | C | 0.11 | D | 4.5 | C | 5.0 | D | 39 | C | 39 | C | 95 | AA |
| Example 30 | 30 | 0.08 | C | 0.11 | D | 4.5 | C | 5.1 | D | 39 | C | 39 | C | 95 | AA |
| Example 31 | 31 | 0.08 | C | 0.11 | D | 4.6 | C | 5.1 | D | 39 | C | 40 | C | 95 | AA |
| Example 32 | 32 | 0.08 | C | 0.11 | D | 4.6 | C | 5.2 | D | 39 | C | 40 | C | 95 | AA |
| Example 33 | 33 | 0.09 | C | 0.11 | D | 4.7 | C | 5.2 | D | 40 | C | 41 | D | 95 | AA |
| Example 34 | 34 | 0.09 | C | 0.12 | D | 4.8 | C | 5.3 | D | 40 | C | 41 | D | 95 | AA |
| Example 35 | 35 | 0.10 | D | 0.12 | D | 4.9 | C | 5.3 | D | 40 | C | 41 | D | 95 | AA |
| Example 36 | 36 | 0.10 | D | 0.12 | D | 4.9 | C | 5.3 | D | 40 | C | 41 | D | 95 | AA |
| Example 37 | 37 | 0.10 | D | 0.13 | D | 5.0 | D | 5.3 | D | 40 | C | 41 | D | 94 | A |
| Example 38 | 38 | 0.10 | D | 0.13 | D | 5.0 | D | 5.3 | D | 40 | C | 42 | D | 94 | A |
| Example 39 | 39 | 0.10 | D | 0.13 | D | 5.0 | D | 5.4 | D | 40 | C | 42 | D | 93 | A |
| Example 40 | 40 | 0.10 | D | 0.13 | D | 5.0 | D | 5.4 | D | 40 | C | 42 | D | 92 | A |
| Example 41 | 41 | 0.11 | D | 0.13 | D | 5.1 | D | 5.4 | D | 41 | D | 42 | D | 91 | A |
| Example 42 | 42 | 0.11 | D | 0.13 | D | 5.1 | D | 5.4 | D | 40 | C | 42 | D | 88 | BB |
| Example 43 | 43 | 0.11 | D | 0.13 | D | 5.1 | D | 5.4 | D | 40 | C | 42 | D | 85 | B |
| Example 44 | 44 | 0.11 | D | 0.13 | D | 5.1 | D | 5.4 | D | 40 | C | 42 | D | 84 | B |
| Example 45 | 45 | 0.11 | D | 0.13 | D | 5.2 | D | 5.5 | D | 40 | C | 43 | D | 83 | B |
| Example 46 | 46 | 0.12 | D | 0.14 | D | 5.2 | D | 5.5 | D | 40 | C | 43 | D | 81 | B |
| Example 47 | 47 | 0.12 | D | 0.14 | D | 5.3 | D | 5.5 | D | 41 | D | 43 | D | 79 | CC |
| Example 48 | 48 | 0.12 | D | 0.14 | D | 5.3 | D | 5.5 | D | 41 | D | 43 | D | 78 | CC |
| C.E. 1 | 49 | 0.13 | D | 0.13 | D | 5.8 | D | 5.9 | D | 42 | D | 43 | D | 40 | E |
| C.E. 2 | 50 | 0.13 | D | 0.14 | D | 5.9 | D | 6.2 | E | 43 | D | 44 | E | 56 | D |
| C.E. 3 | 51 | 0.14 | D | 0.18 | E | 6.2 | E | 6.3 | E | 44 | E | 45 | E | 42 | E |
| C.E. 4 | 52 | 0.14 | D | 0.14 | D | 5.9 | D | 6.1 | E | 43 | D | 45 | E | 72 | C |
| C.E. 5 | 53 | 0.18 | E | 0.19 | E | 6.1 | E | 6.2 | E | 45 | E | 45 | E | 72 | C |
| C.E. 6 | 54 | 0.14 | D | 0.14 | D | 6.1 | E | 6.3 | E | 43 | D | 46 | E | 73 | C |
| C.E. 7 | 55 | 0.20 | E | 0.20 | E | 6.1 | E | 6.3 | E | 43 | E | 46 | E | 43 | E |
| C.E. 8 | 56 | 0.05 | B | 0.07 | D | 2.5 | B | 3.6 | B | 36 | B | 38 | C | 49 | E |

In the table, C.E. denotes comparative example, SD denotes standard deviation, and R denotes rank.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-048993, filed Mar. 24, 2022, and Japanese Patent Application No. 2023-014700, filed Feb. 2, 2023 which are hereby incorporated by reference herein in their entirety.

What is claimed is:

1. A two component developer comprising a toner and a magnetic carrier, wherein
the magnetic carrier comprises a magnetic carrier core particle and a resin coat layer formed on a surface of the magnetic carrier core particle,
the toner comprises a toner particle comprising a binder resin,
the toner particle comprises a surface layer comprising an organosilicon polymer,
after the toner and ion exchanged water are mixed to toner concentration of 1.0 mass %, and are shaken for 1 minute, and then filtering off the toner, electrical conductivity of a filtrate is 1.0 to 2.5 μS/cm, and
when dC (atomic %) denotes a carbon concentration, dO (atomic %) denotes an oxygen concentration and dSi (atomic %) denotes a silicon concentration, as measured by ESCA, at a surface of the toner particle, then the dC, the dO and the dSi satisfy formula (1) and formula (2) below:
40.0≤dC/(dC+dO+dSi)×100≤60.0 (1)
10.0≤dSi/(dC+dO+dSi)×100≤26.0 (2).

2. The two component developer according to claim 1, wherein an amount of silanol groups in the toner particle, as measured by a titration method using potassium hydroxide, is 0.010 to 0.075 mmol/g.

3. The two component developer according to claim 1, wherein in a wettability test of the toner with a mixed methanol/water solvent, methanol concentration at which transmittance of light having a wavelength of 780 nm is 50% is 35.0 to 70.0 vol %.

4. The two component developer according to claim 1, wherein
the organosilicon polymer has a structure in which a silicon atom and an oxygen atom are alternately bonded to each other, and
in a chart obtained by measuring an amount of tetrahydrofuran-insoluble matter in the toner particle by ²⁹Si-NMR, a ratio of an area of a peak derived from a silicon atom assigned to a structure represented by formula (b) below relative to a total area of peaks derived from all silicon atoms comprised in the organosilicon polymer is 0.900 to 1.000: 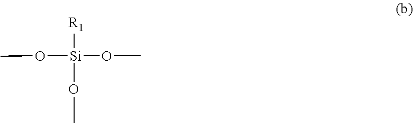
in formula (b), R₁ denotes an alkyl group having 1 to 6 carbon atoms or an aryl group.

5. The two component developer according to claim 1, wherein in a chart obtained by measuring an amount of tetrahydrofuran-insoluble matter in the toner particle by ²⁹Si-NMR, a ratio of an area of a peak derived from a silicon atom assigned to a structure represented by formula (a) below relative to a total area of peaks derived from all silicon atoms comprised in the organosilicon polymer is 0.005 to 0.080: 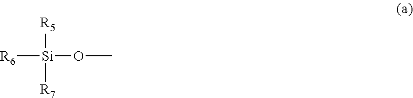
in formula (a), R₅, R₆ and R₇ each independently denote an alkyl group having 1 to 6 carbon atoms.

6. The two component developer according to claim 1, wherein a content of the organosilicon polymer in the toner particle is 4.0 to 30.0 mass %.

7. The two component developer according to claim 1, wherein
the organosilicon polymer has a structure in which a silicon atom and an oxygen atom are alternately bonded to each other, and
in a chart obtained by measuring an amount of tetrahydrofuran-insoluble matter in the toner particle by ²⁹Si-NMR, a ratio (ST3/ST2) of an area (ST3) of a peak derived from a T3 unit structure relative to an area (ST2) of a peak derived from a T2 unit structure in an area of peaks derived from silicon atoms assigned to a structure represented by formula (b) below is 3.0 to 4.5: 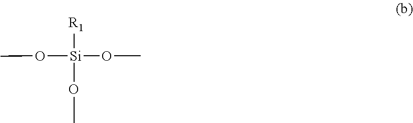
in formula (b), R₁ denotes an alkyl group having 1 to 6 carbon atoms or an aryl group.

8. The two component developer according to claim 1, wherein
the toner particle comprises a release agent, and
in an FT-IR spectrum obtained by measuring the toner particle using an ATR method, and using Ge as an ATR crystal and at an infrared light incident angle of 45°,
when Pa denotes a maximum absorption peak intensity of a value obtained by subtracting an average value of absorption intensity at 3050 cm⁻¹ and 2600 cm⁻¹ from a maximum value of absorption peak intensity within a wavelength range 2843 to 2853 cm⁻¹, and
Pb denotes maximum absorption peak intensity of a value obtained by subtracting an average value of an absorption intensity at 1800 cm⁻¹ and 1650 cm⁻¹ from a maximum value of absorption peak intensity within a wavelength range 1713 to 1723 cm⁻¹, then
Pa and Pb satisfy formula (3) below:
0.150≤Pa/Pb≤0.400 (3)
.

9. The two component developer according to claim 8, wherein the release agent is a hydrocarbon wax.

10. The two component developer according to claim 1, wherein
the binder resin comprises an amorphous resin and a crystalline resin,
the crystalline resin has a first monomer unit represented by formula (x) below, and
proportion of the first monomer unit in the crystalline resin is 20 to 100 mass % relative to a total mass of all monomer units in the crystalline resin: 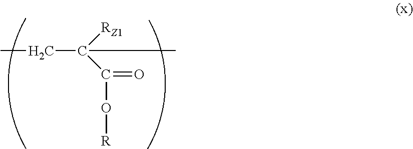
in formula (x), R_{Z1} denotes a hydrogen atom or a methyl group, and R denotes an alkyl group having 18 to 36 carbon atoms.

11. The two component developer according to claim 1, wherein
the magnetic carrier comprises:
a resin-filled magnetic core particle having a porous magnetic particle and a resin present in pores of the porous magnetic particle; and
a resin coat layer present at a surface of the resin-filled magnetic core particle, and
the resin coat layer comprises a copolymer of at least: a (meth)acrylic acid ester having an alicyclic hydrocarbon group; and another (meth)acrylic monomer.

12. A method for producing the two component developer according to claim 1,
wherein
the method comprises a step for mixing the magnetic carrier and the toner having the toner particle,
a step for producing the toner particle comprises:
a first step for obtaining a hydrolyzate of an organosilicon compound having a structure represented by formula (Y) below;
a second step for mixing the hydrolyzate obtained in the first step, toner base particles dispersed in an aqueous medium, and an alkaline aqueous medium, subjecting at least a part of the hydrolyzate to a polycondensation reaction, and forming a surface layer comprising an organosilicon polymer on the toner base particles;
a third step for subjecting the organosilicon polymer comprised in the surface layer formed on the toner base particles to a hydrophobic treatment, and then obtaining a toner particle comprising an organosilicon polymer; and
a fourth step for washing the toner particle obtained in the third step with water: 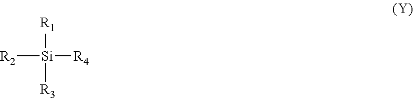
in formula (Y), R₁ denotes a hydrocarbon group having 1 to 6 carbon atoms or an aryl group, and R₂, R₃ and R₄ each independently denote a halogen atom, a hydroxy group, an acetoxy group or an alkoxy group.

13. The method for producing a two component developer according to claim 12, the method comprising a melt kneading step for melt kneading a mixture comprising a binder resin and a release agent to obtain a toner base particle.
